(19) United States
(12) Patent Application Publication
(10) Pub. No.: US 2020/0254358 A1
(43) Pub. Date: Aug. 13, 2020

(54) TERMINAL FOR ACTION ROBOT AND METHOD OF OPERATING THE SAME

(71) Applicant: LG ELECTRONICS INC., Seoul (KR)

(72) Inventors: Mojeong KIM, Seoul (KR); Sanghun KIM, Seoul (KR); Jinho SOHN, Seoul (KR)

(21) Appl. No.: 16/783,619

(22) Filed: Feb. 6, 2020

Related U.S. Application Data
(63) Continuation of application No. PCT/KR2019/001640, filed on Feb. 11, 2019.

(51) Int. Cl. A63J 19/00; B25J 13/00; B25J 13/08

(52) U.S. Cl. CPC A63J 19/006; B25J 13/081; B25J 13/006

(57) ABSTRACT

A terminal for an action robot allows a user to easily manage motion data for controlling movement of the action robot and a method of operating the same. The terminal may include a storage configured to store motion data, a wireless communicator configured to transmit the motion data to an action robot, a display configured to display a motion production screen for generating the motion data, an input interface configured to receive a command for generating pieces of motion part data for controlling motion parts of the action robot through the motion production screen respectively, and a controller configured to generate the motion data by combining the pieces of motion part data.

### CROSS-REFERENCE TO RELATED APPLICATION

This application is a Continuation of PCT/KR2019/001640, filed on Feb. 11, 2019, whose entire disclosure is hereby incorporated by reference.

### BACKGROUND

### 1. Field

The present disclosure relates to a terminal for controlling an action robot and a method of operating the terminal, such as to enable a user to manage motion data for controlling a movement of the action robot.

### 2. Background

A robot may be constructed using, for example, modularizing joints or wheels. For example, a plurality of actuator modules may be electrically and mechanically connected and assembled to each other to construct of various types of robots forms, such as dogs, dinosaurs, humans, spiders, etc.

A robot capable of being manufactured using the plurality of actuator modules may be commonly referred to as a modular robot. Each actuator module included in the modular robot may be equipped with a motor, and the actuator module may execute a motion according to an actuation of the motor. The motions of the actuator modules may be coordinated such that the collective motions of the actuator modules represent a movement of a robot as a whole, such as enable the robot to dance or perform other motions, to interact with users, etc.

Various techniques may be used to allow the robots to dance to music or to perform certain motions or facial expressions in connection with stories, such as fairy tales. For example, a robot performing the dance or other actions (also referred to as an action robot) may perform motions by acquiring and storing data associated with a plurality of preset motions suitable for music or a fairy tale and selectively executing at least one of the preset motions at appropriate times when music or a story is presented. For example, the data for the plurality of preset motions may be acquired from an external device, such as a content server. However, a user typically is not provided an interface for generating or managing motion data for different types of content, and instead, the action robot generally performs motions based on predefined motion data for the content. This, the user typically cannot generate, edit, sell or purchase motion data of an action robot, such as to extract motion data from a video.

### BRIEF DESCRIPTION OF THE DRAWINGS

The embodiments will be described in detail with reference to the following drawings in which like reference numerals refer to like elements wherein:

FIG. 1 is a schematic block diagram illustrating an example of a system including an operating device of a content selling service for an action robot according to an embodiment of the present disclosure.

FIG. 2 is a schematic block diagram of an operating device according to an embodiment of the present disclosure.

FIG. 3 is a diagram for describing an example in which the operating device illustrated in FIG. 1 obtains multimedia content and motion data from a content providing device.

FIG. 4 is a diagram for describing an example in which the operating device illustrated in FIG. 1 obtains multimedia content and motion data from a content providing device and a motion data generating device.

FIG. 5 is a diagram for describing an example in which the operating device illustrated in FIG. 1 transmits and receives motion data to and from a user terminal.

FIG. 6 is a control block diagram of a terminal according to an embodiment of the present disclosure.

FIG. 7 is a flowchart of a method of operating a terminal according to an embodiment of the present disclosure.

FIG. 8 is an exemplary diagram showing a home screen of an application according to an embodiment of the present disclosure, in which part of information or some of icons shown in FIG. 8 may be omitted or other information or other iconds may be further included.

FIG. 9 is an exemplary view of a motion production screen according to an embodiment of the present disclosure.

FIG. 10 is an exemplary view of a shooting guide screen displayed when a motion is extracted through video shooting according to an embodiment of the present disclosure.

FIGS. 11 to 12 illustrate examples of a video shooting screen in the case of motion extraction through video shooting according to an embodiment of the present disclosure.

FIG. 13 is a view illustrating an example of a video location selection screen according to an embodiment of the present disclosure.

FIG. 14 is a view illustrating an example of a video motion extraction screen according to an embodiment of the present disclosure.

FIG. 15 is an exemplary diagram illustrating a method of receiving, by the terminal, a generation command for motion part data according to an embodiment of the present disclosure.

FIG. 16 is an exemplary diagram of a motion value setting screen according to an embodiment of the present disclosure.

FIG. 17 is an exemplary diagram of a motion data generation screen according to an embodiment of the present disclosure.

FIG. 18 is a diagram illustrating a method for displaying a motion list by a terminal according to an embodiment of the present disclosure.

FIGS. 19 to 20 are exemplary diagrams of a motion editing screen according to an embodiment of the present disclosure.

FIG. 21 is an exemplary view of a store screen of action robot content according to an embodiment of the present disclosure.

FIG. 22 is an exemplary view of a content detail screen according to an embodiment of the present disclosure.

FIG. 23 is an exemplary view of a user account screen according to an embodiment of the present disclosure.

FIG. 24 is an exemplary view for describing a method of receiving a motion sales command through a motion list according to an embodiment of the present disclosure.

### DETAILED DESCRIPTION

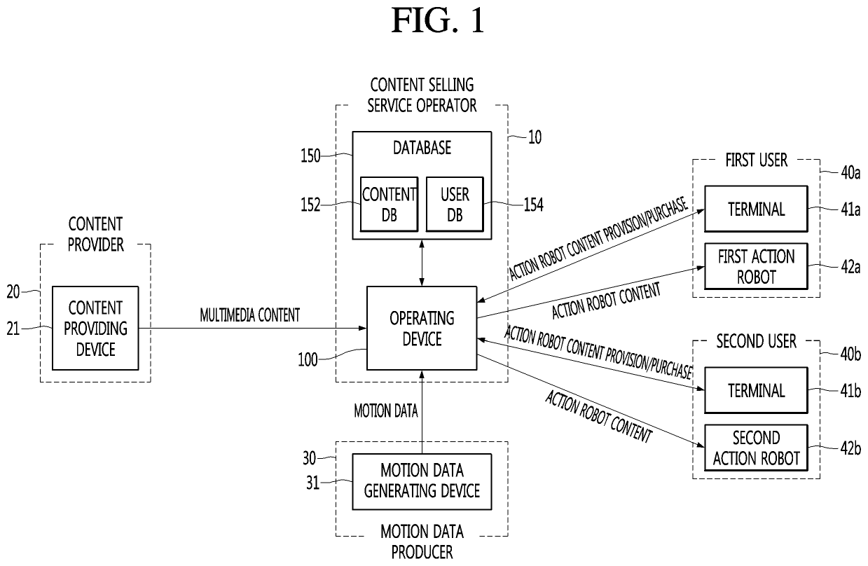

FIG. 1 is a schematic block diagram illustrating an example of a system including an operating device (or content server) of a content selling service that may provide content related for an action robot (also referred to herein as a “robot”). As used herein, the phrase “action robot” may refer to a robot that is configured perform a certain motion, such as a dance.

Referring to FIG. 1, an environment for providing a content for an action robot may include a content selling service operator (or service provider) 10 that performs overall operation and management of a content selling service, at least one content provider 20 that provides multimedia content, at least one motion data producer 30 that provides motion data corresponding to the multimedia content, and a user 40 that purchases and uses action robot content. Although only a first user 40a and a second user 40b are illustrated in FIG. 1, this quantity of users 40 is depicted merely as an example for convenience of description, and the quantity of users 40 (and associated terminals) is not limited thereto.

The content selling service operator 10 may operate and manage the content selling service through the content selling service operating device 100 (hereinafter, referred to as an “operating device” or “transaction server”) and database (or memory) 150. The content provider 20 may provide multimedia content and/or motion data to the operating device 100 through a content providing device (or content server) 21. The motion data producer 30 may produce or otherwise generate motion data corresponding to specific multimedia content through a motion data generating device 31, and provide the generated motion data to the operating device 100.

Each of the plurality of users 40 may request the purchase of action robot content from the operating device 100 through the her/his terminal 41 and receive the action robot content through the terminal 41 or an action robot 42. Similarly, although only a first terminal 41a and a second terminal 41b are illustrated as the terminal 41, and only a first action robot 42a and a second action robot 42b are illustrated as the action robot 42 in FIG. 1, the environment shown in FIG. 1 may include different numbers of terminals or action robots. For example, first user 40a may be associated with multiple action robots 42a that are managed by first terminal 41a.

The action robot content received from the operating device 100 may include multimedia content, such as the multimedia content provided by the content providing device 21, and motion data corresponding to the multimedia content. The multimedia content may include, for example, a variety of content such as music, stories (e.g., fairy tales), educational lectures, movies, podcasts, conversations, etc. For example, when the multimedia content is music, the motion data may represent a dance (choreography) corresponding to the music. When the multimedia content is audio, such as fairy tale content, education content, or conversation content, the motion data may represent various motions, such as movements, poses, emotional expressions, and reactions of a person or character associated with the content.

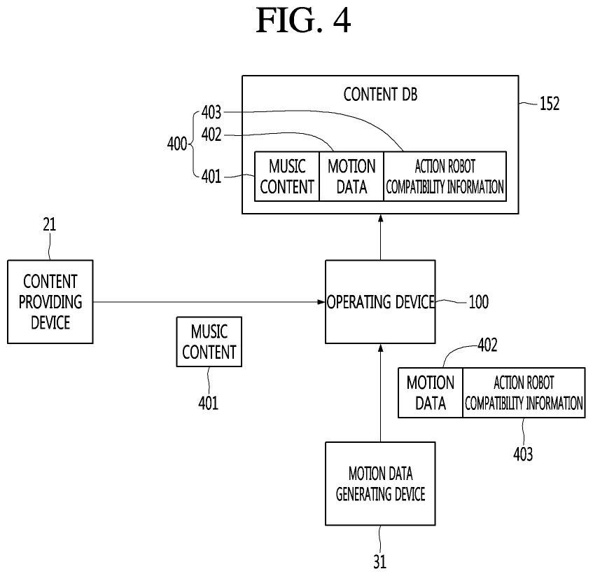

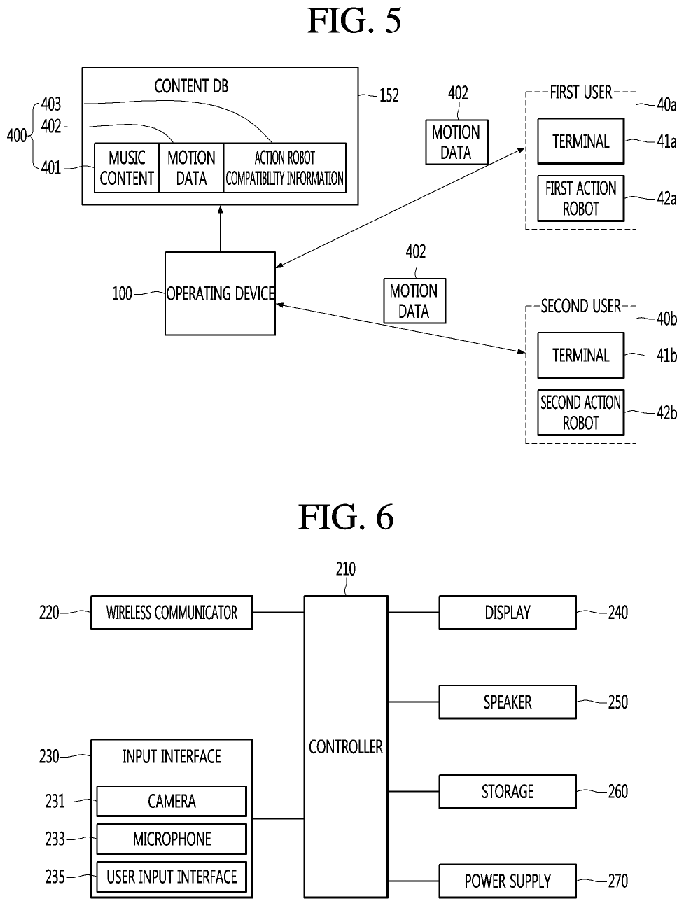

In certain examples, the action robot content may include motion data corresponding to specific multimedia content or may further include motion condition and expression condition information of the motion data. The action robot content will be described in more detail later with reference to FIGS. 3 to 4.

The operating device 100 may provide information corresponding to a list, a catalog, or the like of the action robot content (or multimedia content) to a user terminal 41a or 41b, and receive a request for the action robot content from the terminal 41a or 41b. For example, the terminal 41a or 41b may provide a purchase request for certain multimedia content. Based on the received purchase request, the operating device 100 may generate action robot content that includes the requested multimedia content and motion data corresponding to the action robot 42a or 42b associated with a user, and provide the generated action robot content to the action robot 42a or 42b. For instance, the operating device 100 may determine motion data for the requested multimedia content that can be performed by the particular type, model, brand, etc. of the action robot 42a or 42b. In one example, the operating device 100 may provide the generated action robot content to the action robot 42a or 42b through the associated terminal 41a or 41b.

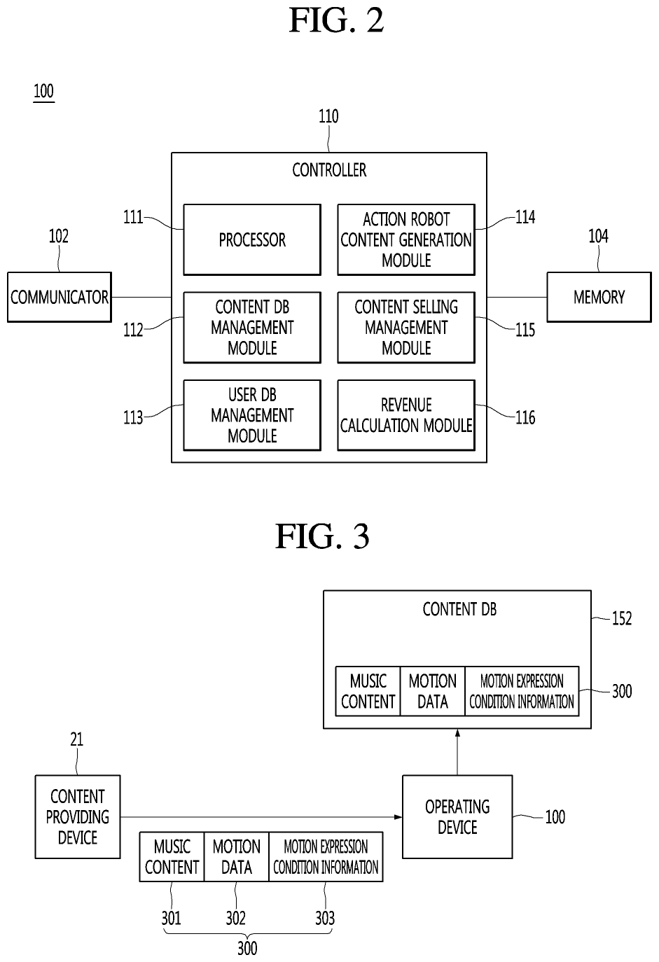

The operating device 100 may be implemented with a computing device such as a server, and may include a plurality of components for performing the above-described operations related to receiving a request for multimedia content and providing the requested multimedia content with the movement data for an associated action robot 42a, 42b. The plurality of components included in the operating device 100 will be described in more detail later with reference to FIG. 2.

The database (or memory or cloud server) 150 may store a variety of information related with the provision of the content selling service. For example, database 150 may include content database (DB) (or content memory) 152 and a user database DB (or user memory) 154. For example, the term “database” may include any organized collection of data, generally stored and accessed electronically and may include a database management system (DBMS) or other software that interacts with end users, applications, and the database itself to capture and analyze the data. In other examples, the database may include any memory the receives and stores the multimedia content and information regarding the users 40a, 40b.

The operating device 100 may store multimedia content obtained from the content providing device 21 of the content provider in the content DB 152. In addition, the operating device 100 may store the motion data obtained from the content providing device 21 or the motion data generating device 31 in the content DB 152. In certain examples, the content DB 152 may store a plurality of pieces of content data. For example, each of the plurality of pieces of content data may include multimedia content for generating action robot content, and/or at least one motion data for the multimedia content. Each of the at least one motion data may correspond to at least one of various types of action robots. In some examples, the action robot may perform appropriate motions by processing a portion of the motion data included in the content data that corresponds to that action robot.

The user DB 154 may store user data of each of a plurality of users who use the content selling service. For example, the user data may include identification information (e.g., a user ID) of the user, action robot information (e.g., model information) of the user, internet protocol (IP) address information of the action robot, IP) address information of the terminal 41a, 41b, content purchase history of the user, and the like.

According to an embodiment, the database 150 may be integrated with the operating device 100. In another example, the database 150 may be included in a device, such as a cloud server or other computing device, that is separate the operating device 100.

The content providing device 21 may be implemented with a computing device that provides multimedia content to the operating device 100. For example, the content providing device 21 may be implemented with a server operated by the content provider 20. According to an embodiment, the content providing device 21 may include a terminal such as a PC, a smartphone, a tablet PC, or the like.

The motion data generating device 31 may be implemented with a computing device that provides motion data for specific multimedia content to the operating device 100. For example, the content selling service operator 10 may provide an application for generating motion data to the motion data generating device 31 through the operating device 100 or another computing device.

The motion data producer 30 may generate motion data for multimedia content through an application executed in the motion data generating device 31. For example, the motion data producer 30 may parse the multimedia content to identify certain attributes, such as changes in volume and/or tempo in audio contents, a tempo of related sounds, a key of music, dominant colors, changes in light intensity and/or colors, etc. and identify movements that coordinate with the identified attributes. The motion data generating device 31 may transmit or upload the generated motion data to the operating device 100. The operating device 100 may store the received motion data in the content DB 152 or store together the motion data and multimedia content corresponding to the motion data in the content DB 152.

Meanwhile, the terminal 41 may receive an application related with the motion of the action robot, and the application provided to the terminal 41 may be identical or similar to the application provided to the motion data generating device 31.

In another example, the content provider 20 may generate the motion data and may provide the generated motion data to the operating device 100. In this implementation, the content provider 20 may be included in or correspond to the motion data producer 30.

The terminal 41a or 41b may provide a list of multimedia content corresponding to action robot content to is purchasable or otherwise available to a user 40a or 40b, and may receive a purchase request for specific action robot content from the user 40a or 40b. The terminal 41a or 41b may include a computing or user device, such as a smartphone, a tablet PC, a notebook PC, a PC, and the like.

For example, the list of available multimedia content available to a user 40a or 40b may include a list of at least one multimedia content for which corresponding motion data is present in the database 150. The terminal 41a or 41b may output the list through a display or the like that is included in or coupled to the terminal 41a or 41b, and the user 40a or 40b may input a request to purchase or otherwise acquire action robot content corresponding to the multimedia content by selecting desired multimedia content among the multimedia contents included in the list. The terminal 41a or 41b may transmit the input request to the operating device 100. The operating device 100 may then transmit the action robot content to the action robot 42a or 42b and/or to the terminal 41a or 41b of the user based on the received request.

The action robot 42a or 42b may refer to a robot that performs an operation, such as dancing or a motion. For example, the action robot 42a and 42b may perform the operation based on controlling a movement of at least one joint through a robot driving part including an actuator module including one or more motors. In addition, the action robot 42a or 42b may include a speaker and/or a display for outputting multimedia content implemented in a visual or auditory form, such as music and images. Accordingly, the action robot 42a or 42b may be able to provide more lively content to the user by processing and outputting multimedia content included in the action robot content while also performing actions based on the corresponding motion data which is also included in the action robot content.

According to an embodiment, the action robot 42a or 42b may include a virtual action robot implemented on a robot simulator included in a computing device (e.g., a personal computer (PC) or gaming device). The robot simulator may output the action robot 42a or 42b in a graphic form through a display of the computing device.

FIG. 2 is a schematic block diagram of an operating device 100 of a content service operator 10 according to an embodiment of the present disclosure. Referring to FIG. 2, the operating device 100 may include a communicator 102, a memory 104, and a controller 110. The components illustrated in FIG. 2 are not essential to implementing the operating device 100, and the operating device 100 may include more or less components.

The communicator 102 may include at least one communication module or device that connects the operating device 100 to the database 150 or connects the operating device 100 to the content providing device 21, the motion data generating device 31, the terminal 41a or 41b, the action robot 42a or 42b, and the like. For example, the communicator 102 may be a module having an antenna and a transceiver that support a wireless communication scheme, such as a wireless Internet module supporting Wi-Fi® or a mobile communication module supporting 3G, 4G such as LTE (long term evolution), 5G, or other mobile wireless data standard, or a module that supports a wired communication scheme such as Ethernet.

As described above with reference to FIG. 1, the operating device 100 may receive multimedia content and/or motion data from the content providing device 21 connected through the communicator 102 and/or may receive motion data from the motion data generating device 31. In addition, the operating device 100 may transmit a list of multimedia content corresponding to available action robot content to the terminal 41a or 41b connected through the communicator 102, or receive a request for action robot content from the terminal 41a or 41b. In addition, the operating device 100 may transmit the action robot content to the action robot 42a or 42b through the communicator 102.

The memory 104 may store a variety of types of data, such as control data for controlling operations of components included in the operating device 100, data for performing an operation corresponding to a request or a command obtained through the communicator 102, and the like. In addition, the memory 104 may store program data for operations of a content DB management module 112, a user DB management module 113, an action robot content generation module 114, a content selling management module 115, and a revenue calculation module 116, which will be described later. The processor 111 of the controller 110 or another controller may control an operation of each of the modules 112 to 116 based on the program data.

According to an embodiment, the database 150 1 may be integrated with the operating device 100, and the memory 104 may be understood as including the database 150. The memory 104 may include various storage devices such as a ROM, a RAM, an EPROM, a flash drive, a hard drive, and the like, in hardware.

The controller 110 may include at least one processor or controller for controlling the operation of the motion generating device 20. For example, each of the at least one processor or controller may be implemented with a CPU, an application processor (AP), a microcomputer (or a microcontroller), an integrated circuit, an application specific integrated circuit (ASIC), or the like. For example, the processor 111 included in the controller 110 may control overall operations of one or more the components included in the operating device 100. For example, the processor 111 may load program data of each of the modules 112 to 116 stored in the memory 104, and the processor 111 may execute each of the modules 112 to 116. For example, the operation of each of the modules 112 to 116 may be controlled by another processor or controller included in the processor 111 or the controller 110.

The content DB management module 112 may perform management on the plurality of pieces of content data such as generation, change, deletion, or the like of the plurality of pieces of content data stored in the content DB 152. For example, the content DB management module 112 may generate content data including multimedia content received from the content providing device 21 and motion data for the multimedia content provided from the motion data generating device 31 and store the generated content data in the content DB 152. According to an embodiment, the motion data may be received from the content providing device 21.

In certain examples, the content data in the content DB 152 may include a plurality of pieces of motion data corresponding to the multimedia content. The plurality of motion data may be received from at least one motion data generating device 31. Each of the plurality of pieces of motion data may correspond to at least one of various types of action robots.

The content DB management module 112 may change the content data corresponding to the multimedia content to include the received motion data when motion data for the multimedia content stored in the content DB 152 is additionally received from the motion data generating apparatus 31. In addition, the content DB management module 112 may delete multimedia content and/or motion data stored in the content DB 152 in response to a delete request received from the content providing device 21 or the motion data generating device 31.

The content DB management module 112 may load content data corresponding to a purchase request from the content DB 152 in response to the purchase request received from the user's terminal. For example, the content DB management module 112 may provide the multimedia data and motion data included in the loaded content data to the action robot content generation module 114. According to an embodiment, when the plurality of pieces of motion data is included in the content data, the content DB management module 112 may provide motion data corresponding to the user's action robot to the action robot content generation module 114. These and other operations associated with the content DB management module 112 will be described in more detail later with reference to other drawings.

The user DB management module 113 may perform management, such as generation, change, deletion, or the like on a plurality of pieces of user data stored in the user DB 154. For example, the user DB management module 113 may load user data for the user from the user DB 154 in response to a purchase request for action robot content received from the user's terminal. Additionally, the user DB management module 113 may provide action robot information (e.g., model information) included in the loaded user data to the content DB management module 112. In addition, the user DB management module 113 may provide the processor 111 with address information (e.g., an IP address) of an action robot included in the loaded user data.

The action robot content generation module 114 may generate action robot content including multimedia content and motion data provided from the content DB management module 112. According to an embodiment, there may be a plurality of pieces of motion data corresponding to the user's action robot, and the action robot content generation module 114 may generate action robot content including the motion data selected by the user through the terminal among the plurality of pieces of motion data. When the action robot content is generated by the action robot content generation module 114, the processor 111 may transmit the action robot content to the user's action robot based on the address information of the action robot, as stored in the user DB 154.

Meanwhile, the operating device 100 may calculate a revenue of the content provider 20 and the motion data producer 30 based on the selling information of the multimedia content and the motion data included in the action robot content. For example, the content selling management module 115 may manage selling information (e.g., selling amount) of each of multimedia content and motion data provided (sold) to action robots of users. The revenue calculation module 116 may calculate the revenue of the content provider 20 based on, for example, the selling amount of the multimedia content, and calculate the revenue of the motion data producer 30 based on the selling amount of the motion data. The content selling service operator 10 may provide a cost corresponding to revenue for each of the content provider 20 and the motion data producer 30 based on the revenue calculated by the revenue calculation module 116.

FIG. 3 is a diagram for describing an example in which the operating device 100 obtains multimedia content 301 and motion data 302 from a content providing device 21. In the following description, multimedia content 301 is described as music content, but the following embodiments may be applied to a variety of multimedia content, such as education content, conversation content, game content, fairy tale content, or the like that differs from music content but may be handled in a substantially similar manner.

Referring to FIG. 3, multimedia content 301 and motion data 302 may be provided by the content providing device 21. For example, the content provider 20 may directly generate motion data for the multimedia content and provide the same to the operating device 100 through the content providing device 21. The operating device 100 may receive content data 300 including the multimedia content (e.g., the music content 301) and the motion data 302 from the content providing device 21, and store the received content data 300 in the content DB 152.

According to an embodiment, the content data 300 may further include motion expression condition information 303. The motion expression condition information 303 may include, for example, guide information or information on main motions which allows the motion data producer 30 to generate motion data for the multimedia content 301. For example, the motion data 302 may include control values (e.g., rotation angle) of joints for a motion associated with the music content 301, or control information of motors. In this implementation, the motion data 302 may be processed by the action robot having the joints associated with the control values in the motion data 302, and may not be processed by a different type of action robot that does not include some of the joints, such that at least a portion of the motion data cannot be used by the different type of action robot. Accordingly, the motion expression condition information 303 may include guide information for implementing main motions among motions related with the multimedia content 301 or rotation angle information of each of the joints.

According to an embodiment, the motion data 302 provided from the content providing device 21 may include reference motion data for generating motion data corresponding to each of several types of action robots such as an algorithm for generating certain types of motions, not specialized motion data corresponding to a specific action robot. In this example, the processor 111 of the operating device 100 may provide the motion expression condition information 303 or the reference motion data to the motion data generating device 31 (or a motion data generating application implemented by the operating device 100). The motion data producer 30 may then generate specific motion data corresponding to a specific action robot based on the motion expression condition information 303 or the reference motion data.

Referring to FIG. 4, the operating device 100 may obtain multimedia content (e.g., music content 401) from the content providing device 21, and obtain motion data 402 for the music content 401 from the motion data generating device 31. For example, the operating device 100 may store the content data 400 including the obtained music content 401 and the motion data 402 in the content DB 152.

According to an embodiment, the operating device 100 may obtain different pieces of motion data 402 for the music content 401 from a plurality of motion data generating devices 31, such that the content data 400 may include a plurality of pieces of motion data. For example, when there are various different kinds of action robots, such as action robots having different positions and/or numbers of joints, respective motion data corresponding to each of the different types of the action robots may be generated the different motion data generating devices 31, and provided to the operating device 100 for storage and use. Since it may be difficult for the content provider 20 to produce all of a plurality of pieces of motion data corresponding to each of the action robots, the motion data 402 may be generated and provided by a plurality of motion data producers 30.

According to an embodiment, the operating device 100 may further obtain action robot compatibility information 403 for the motion data 402 from the motion data generating device 31. The operating device 100 may store content data 400 including music content 401, motion data 402, and action robot compatibility information 403 in the content DB 152.

The action robot compatibility information 403 may include information (e.g., model information) on at least one action robot capable of processing the motion data 402. For example, the action robot compatibility information 403 may identify a brand, model, type, or other attribute of a robot, such as identifying quantities and types of joints used in robot. According to an embodiment, the action robot compatibility information 403 may correspond to the motion expression condition information 303 of FIG. 3. According to an embodiment (not shown in FIG. 4), the content data 400 may not include multimedia content. In this example, the content data 400 may include the motion data 402, the action robot compatibility information 403, and information indicating to which multimedia content the motion data 402 corresponds.

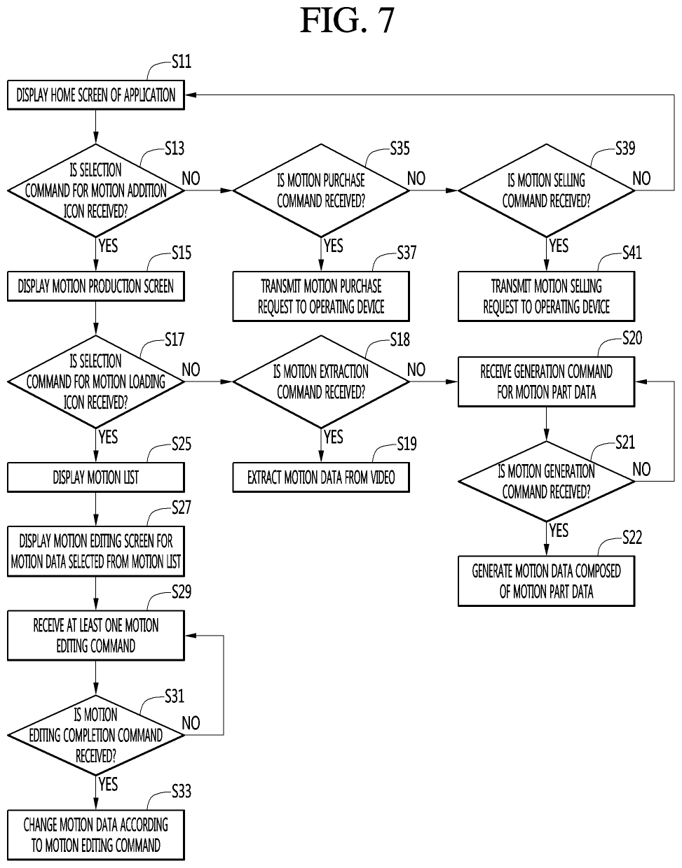

FIG. 5 is a diagram for describing an example in which the operating device 100 may transmit exchange motion data with a user terminal 40a or 40b. For instance, the operating device 100 may store the content data 400 received from the content providing device 21 and the motion data generating device 31 in the content DB 152. In addition, the operating device 100 may transmit and receive the content data 400 to and from the user 40a or 40b. For example, the operating device 100 may transmit the content data 400 to at least one of the terminals 41a and 41b and the action robots 42a and 42b, or the terminal 41a or 41b may transmit the content data 400 to the operating device 100.

The content data 400 may include at least one of the music content 401, the motion data 402, and the action robot compatibility information 403. The user 40a or 40b may purchase or otherwise request at least one of the music content 401 and the motion data 402 from the operating device 100 through the terminal 41a or 41b. Alternatively, the user 40a or 40b may sell the motion data 402 to at least one of the content provider 20, the motion data producer 30, or another user through the terminal 41a or 41b. The terminal 41a or 41b may perform at least one of generation, extraction, editing, selling, and purchasing of motion data, as described below. For example, a terminal 41a or 41b may obtain the motion data from a first content service provider 10 and upload the motion data to the operating device 100 for a second content service provider 10

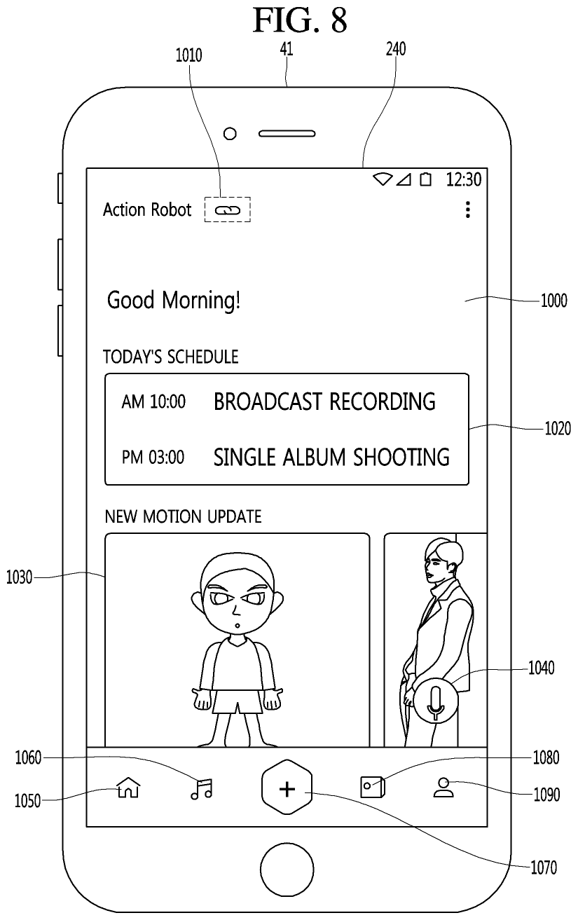

FIG. 6 is a control block diagram of a terminal 41 according to an embodiment. As shown in FIG. 6, the terminal 41 may include, for example, at least one of a controller 210, a wireless communicator 220, an input interface 230, a display 240, a speaker 250, storage 260, and a power supply 270.

The controller 210 may control the operation of the terminal 41. The controller 210 may control the wireless communicator 220, the input interface 230, the display 240, the speaker 250, the storage 260, and the power supply 270 individually. The controller may include, for example, a processor or processing circuitry that implements software to perform certain tasks and functions.

The wireless communicator 220 may include one or more modules that enable wireless communication between the terminal 41 and an external device. The wireless communicator 220 may wirelessly communicate, for example, with at least one of the operating device 100 and the action robot 42. For example, the wireless communicator 220 may include an antenna to exchange signals with another device, and a transceiver to exchange signals with another device via the antenna.

The controller 210 may control the wireless communicator 220 to transmit and receive the content data 400 between the terminal 41 and the operating device 100, as depicted in FIG. 5. In addition, the wireless communicator 220 may directly transmit the content data 400 to another terminal 41. The wireless communicator 220 may also transmit and receive the content data 400 to and from the action robot 42. The wireless communicator 220 may transmit and receive the content data 400 to and from the action robot 42 connected to the terminal 41.

The input interface (or input device) 230 may include a camera 231 for inputting an image signal, a microphone 233 for inputting an audio signal, and a user input interface (or user input device) 235 for receiving information from a user. The user input interface 235 may include, for example, a touch screen, a touch key, a mechanical key, and the like.

The display 240 may display information. For example, the display 240 may display a motion production screen, a motion simulation, or the like. The display 240 may implement a touch screen by forming a layer structure or an integrated structure with the touch sensor. Thus, the display 240 and the input interface 230 may be included in a single device. The display 240 may be provided with a speaker 250 that outputs an audio signal, such as to provide an audio signal corresponding to display information provided by the display 240.

The storage 260 may store various data and information related to the operation of the terminal 41a or 41b. The storage 260 may store, for example, the content data 400. The storage 260 may include at least one type of storage medium such as a flash memory type, a hard disk type, a solid state disk type, an Silicon Disk Drive type (SDD) type, a multimedia card micro type, a card type memory (e.g., SD or XD memory), a random access memory (RAM), a static random access memory (SRAM), read-only memory (ROM), an electrically erasable programmable read-only memory (EEPROM) programmable read-only memory (PROM), a magnetic memory, a magnetic disk, or an optical disk.

The power supply 270 may receive external power or internal power source under the control of the controller 210 and supply power for the operation of each component. The power supply 270 may include, for example, a battery, and the battery may be a built-in battery configured to be rechargeable, and may be detachably coupled to a terminal body for charging or the like.

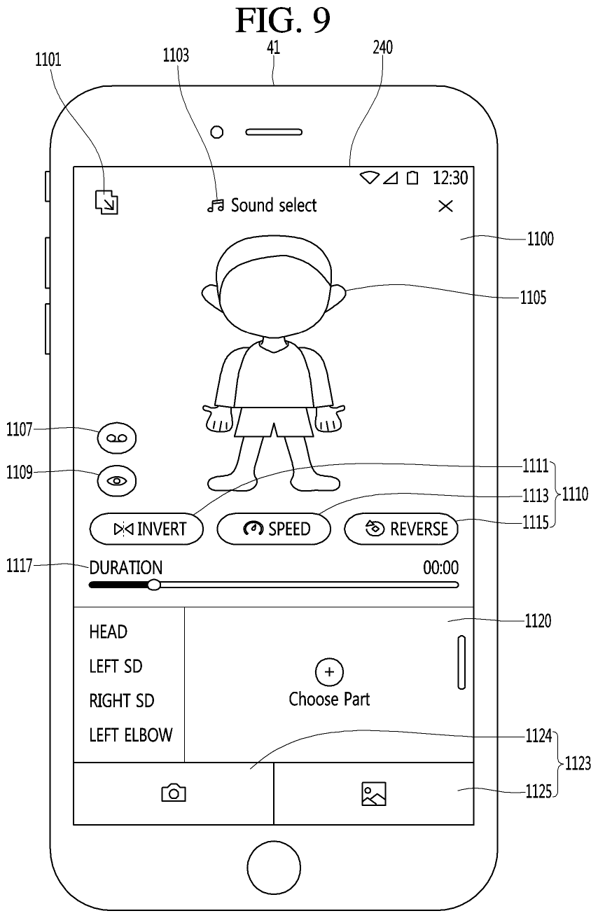

FIG. 7 is a flowchart of a method of operating a terminal 41 according to an embodiment. As shown in FIG. 7, the terminal 41 according to an embodiment of the present disclosure may install and execute an application related to a motion of an action robot (hereinafter, referred to as an “application”). The terminal 41 may perform at least one of generation, extraction, editing, selling, or purchasing on motion data of the action robot through the application. The terminal 41 may receive an application from at least one of the operating device 100, the content provider 20, and the motion data producer 30. In one example, an application provided by the motion data generating device 31 may be the same as or similar to an application executed in the terminal 41.

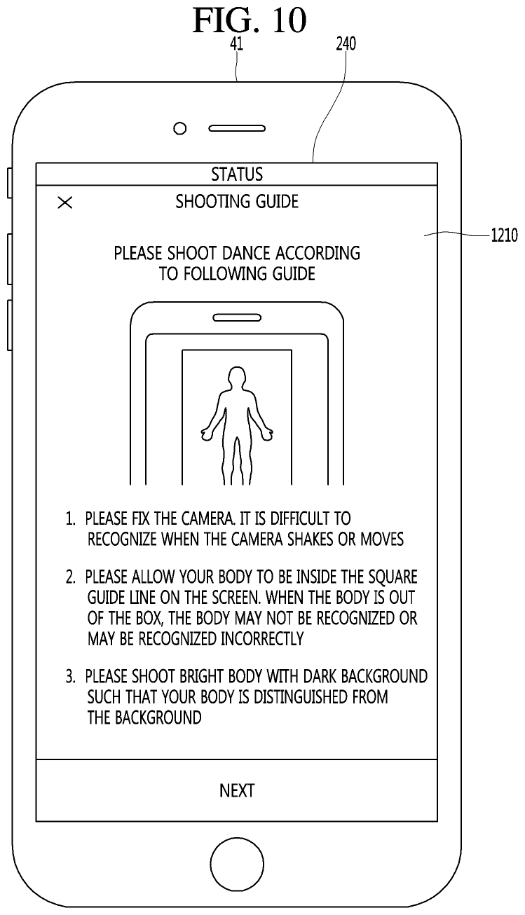

The display 240 may display a home screen of the application (S11). As previously described, the application may be an application that provides at least one function of generation, extraction, editing, selling, or purchasing for the motion data of the action robot 42. For example, FIG. 8 is an exemplary diagram showing a home screen 1000 of an application according to an embodiment of the present disclosure. The display 240 of the terminal 41 may display a home screen 1000 of the application, as illustrated in FIG. 8. However, the home screen 1000 of the application illustrated in FIG. 8 is merely an example for convenience of description and is not limited thereto. The application home screen shown in FIG. 8 is exemplary, and some of the information and icons shown in FIG. 8 may be omitted or modified, or other information or other icons may be further included.

The home screen 1000 of the application may be a screen displayed first when the application installed in the terminal 41 is executed. The home screen 1000 of the application may include at least one of an action robot connection icon 1010, selection information 1020, motion update information 1030, a speech recognition icon 1040, a home icon 1050, a content icon 1060, a motion addition icon 1070, an information icon 1080, or a user icon 1090.

The action robot connection icon 1010 may be an icon for connecting to any one action robot 42. When receiving a command for selecting the action robot connection icon 1010, the controller 210 may display an action robot connection screen (not shown) including at least one of a connection state with the action robot 42 and information of the connected action robot 42. The action robot connection screen (not shown) may include a connection state between the terminal 41 and the action robot 42 (for example, normal connection, non-connection, connection error, or the like), information of the action robot 42 connected to the terminal 41 (e.g., model information or ID), and the like.

The selection information 1020 may include information previously selected by the user through an application. The selection information 1020 may be information related to specific multimedia content, and the specific multimedia content may be content related to a model of the action robot 42 connected to the terminal 41. For example, when the model of the action robot 42 connected to the terminal 41 is artist A, the selection information 1020 may include at least one of the schedule, news, and SNS of the artist A. In addition, when the model of the action robot 42 connected to the terminal 41 is education character B, the selection information 1020 may include new content news related to the education character B.

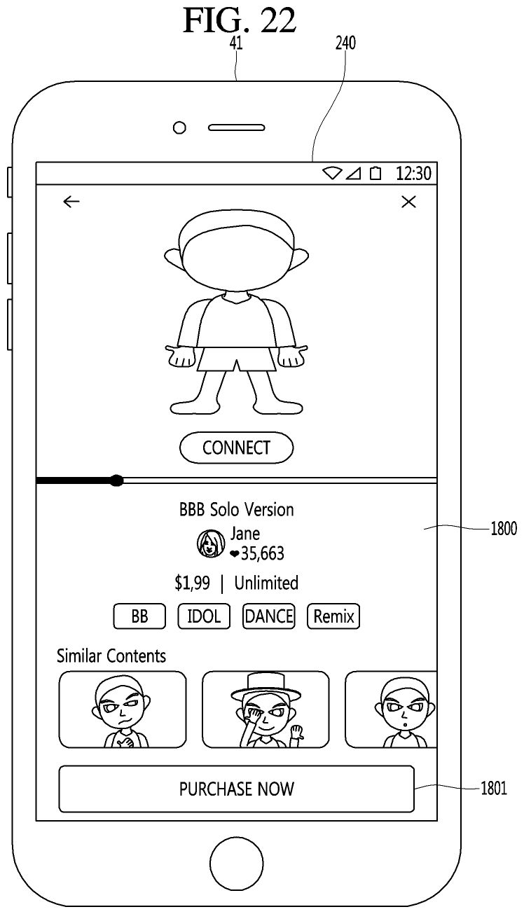

The motion update information 1030 may include news of motion data of the action robot 42 connected to the terminal 41. For example, the motion update information 1030 may include motion data information of the action robot 42 added to the operating device 100. When receiving a selection command for the motion update information 1030, the controller 210 may display a motion information screen according to the selected motion update information 1030. The motion information screen will be described later with reference to FIG. 22.

The speech recognition icon 1040 may be an icon for receiving a speech command. The controller 210 may receive a command related to at least one of generation, extraction, editing, selling, and purchasing of motion data through the speech recognition icon 1040.

At least one of the home icon 1050, the content icon 1060, the motion addition icon 1070, the information icon 1080, and the user icon 1090 may be continuously displayed while the application is running. For example, the home icon 1050 may be a command for displaying a home screen of an application. The controller 210 may display the home screen 1000 of the application as illustrated in FIG. 8 when receiving a selection command for the home icon 1050.

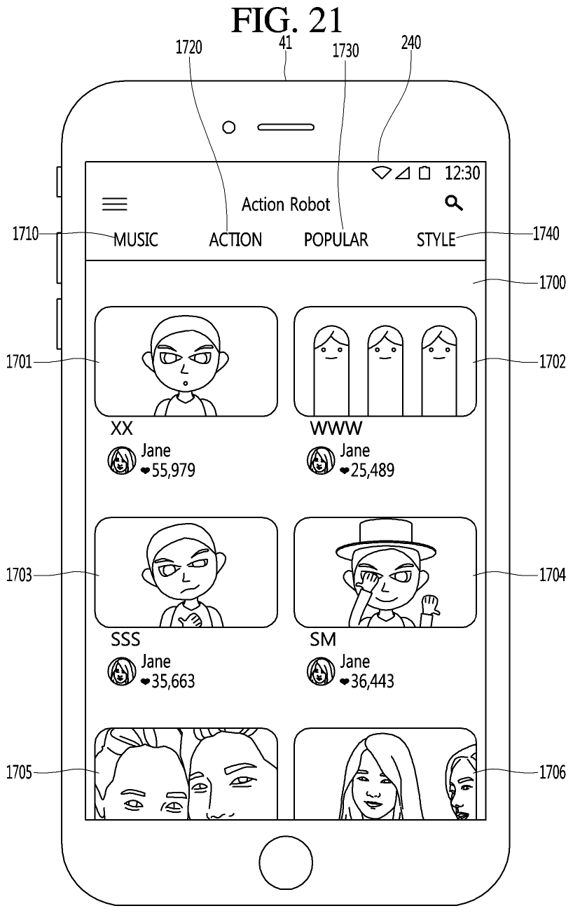

The content icon 1060 may be an icon for displaying a store screen of action robot content. The controller 210 may display a store screen 1700 of the action robot content (see FIG. 21) when the selection command for the content icon 1060 is received. The store screen of the action robot content (hereinafter, referred to as a “store screen”) may include selling information of multimedia content such as music, fairy tale, education, and conversation, selling information of multimedia content and motion data corresponding thereto, and motion data, and selling information of the motion data. The controller 210 may receive a purchase command of multimedia content, a purchase command of multimedia content and motion data corresponding thereto, and a purchase command of motion data, through the store screen of the action robot content (not shown).

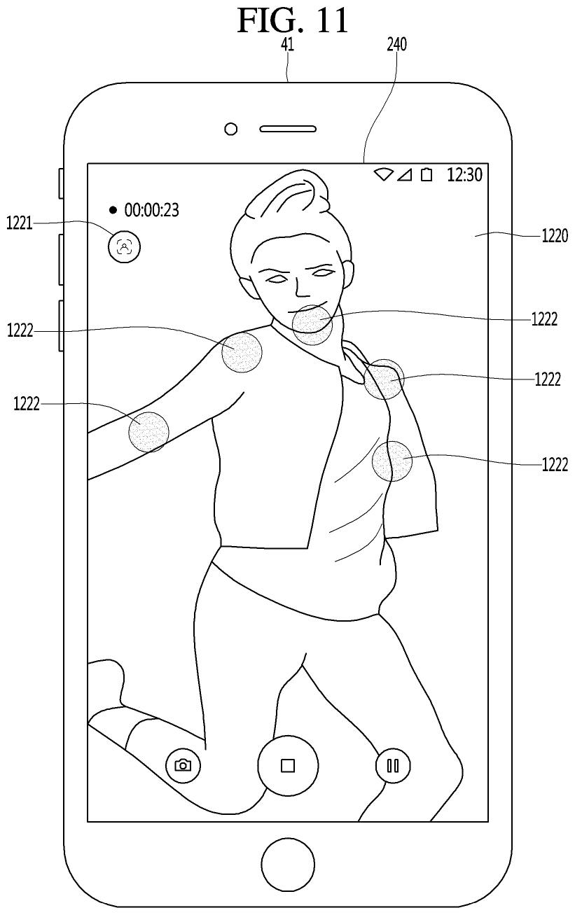

The motion addition icon 1070 may be an icon for producing motion data. The user may select the motion addition icon 1070, and when the controller 210 receives a selection command for the motion addition icon 1070, the controller 210 may display a motion production screen as illustrated in FIG. 9. The motion production screen will be described later with reference to FIG. 9.

The information icon 1080 may be an icon for displaying related information of the action robot content. The controller 210 may display the related information of the action robot content when receiving the selection command for the information icon 1080. The related information of the action robot content may include information related to the action robot 42, information related to the motion data of the action robot 42, and the like.

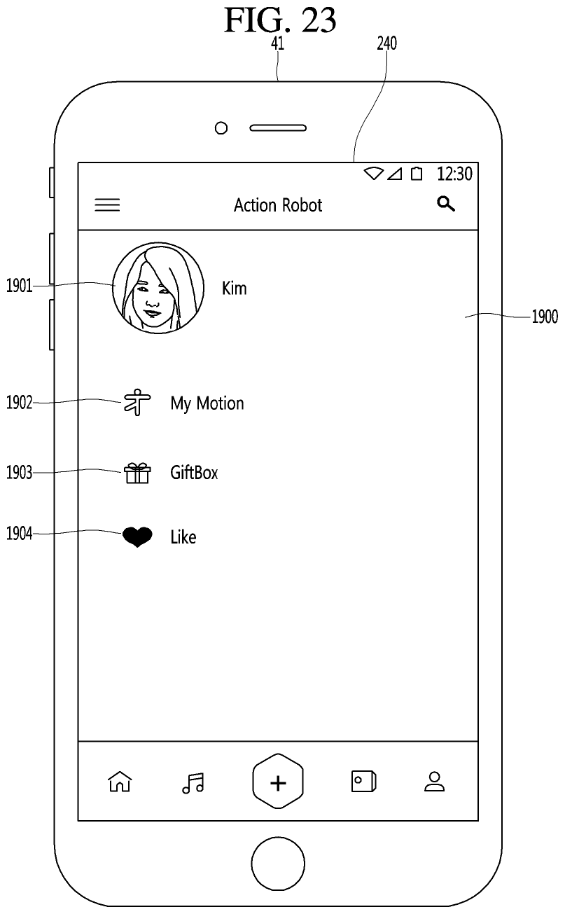

The user icon 1090 may be an icon for displaying account information of the user. The controller 210 may display a user account screen 1900 (see FIG. 23) when receiving a selection command for the user icon 1090, and the user account screen may be a screen for displaying information of an action robot held by a user, information of motion data, or the like. The user account screen will be described later with reference to FIG. 23.

Referring back to FIG. 7, the controller 210 may determine whether a selection command for a motion addition icon is received (S13). For example, the controller 210 may receive the selection command for a motion addition icon 1070 displayed on the application home screen 1000, as illustrated in FIG. 8. For example, the controller 210 may obtain whether a selection command for the motion addition icon 1070 is received.

When the controller 210 receives the selection command for the motion addition icon 1070, the controller 210 may display a motion production screen (S15). In one example, the motion production screen may be an icon for producing motion data of the action robot 42 and may be a screen for generating new motion data or editing at least a part of previously-produced motion data. That is, the production of motion data may include generation and editing of motion data.

FIG. 9 is an exemplary view of a motion production screen 1100 according to an embodiment of the present disclosure. For example, the controller 210 may display a motion production screen 1100 as illustrated in FIG. 9 when receiving a selection command for a motion addition icon 1070. The motion production screen 1100 may include at least one of a motion loading icon 1101, a sound source selection icon 1103, an action robot simulation 1105, an automatic motion data generation icon 1107, a multi-view icon 1109, a motion effect icon 1110, a duration icon 1117, a motion setting icon 1120, and a motion production option icon 1123. The motion production screen 1100 illustrated in FIG. 9 is merely exemplary, and at least some of the icons illustrated in FIG. 9 may be omitted or modified, or the motion production screen 1100 may further include other icons.

The motion loading icon 1101 may be an icon for loading previously-produced motion data. The user may load the previously-produced motion data through the motion loading icon 1101 and edit the motion data. The sound source selection icon 1103 may be an icon for selecting multimedia content such as music, a fairy tale, education, and conversation. The sound source selection icon 1103 may be an icon for selecting an audio signal to be played together with the motion data to be produced. The controller 210 may display at least one of multimedia content stored in the terminal 41 and multimedia content provided through the operating device 100 when receiving a selection command for the sound source selection icon 1103.

The action robot simulation 1105 may display a motion of the action robot 42 in advance, and the controller 210 may previously display the motion of the action robot 42 through the action robot simulation 1105 as at least one of the motion effect icon 1110, the duration icon 1117, the motion setting icon 1120, and the motion production option icon 1123 is selected.

The automatic motion data generation icon 1107 may be an icon for automatically generating motion data for reproducing a movement of the action robot 42 connected to the terminal 41. When the controller 210 receives the selection command for the automatic motion data generation icon 1107 while the automatic motion data generation function is in an off state, the controller 210 may turn on the automatic motion data generation function. When the controller 210 receives the selection command for the automatic motion data generation icon 1107 while the automatic motion data generation function is in an on state, the controller 210 may turn off the automatic motion data generation function.

When the automatic motion data generation function is turned on, the controller 210 may detect a movement of the action robot 42 connected to the terminal 41 and generate motion data for reproducing the movement of the detected action robot 42. That is, when the automatic motion data generation function is turned on, the controller 210 may obtain movement information of the action robot 42 connected to the terminal 41 and generate motion data based on the movement information of the action robot 42.

When the action robot 42 is driven by the motion data generated through the automatic motion data generation function, the motion robot 42 may perform the same motion as the movement in a state in which the automatic motion data generation function is turned on. The user may generate the motion data by manually moving the action robot 42 in the state in which the motion data generation function is turned on.

The controller 210 may display the automatic motion data generation icon 1107 differently according to the on or off state of the automatic motion data generation function. For example, when the automatic motion data generation function is in the on and off states, the controller 210 may differently display a color of the automatic motion data generation icon 1107.

The multi-view icon 1109 may be an icon for changing a display method of the action robot simulation 1105. When the controller 210 receives a selection command for the multi-view icon 1109, the controller 210 may display the action robot simulation 1105 in any one of a front view, a rear view, a left view, a right view, a top view, a bottom view, and a perspective view. The front view is a view in which the front of the action robot 42 is displayed, the rear view is a view in which the rear of the action robot 42 is displayed, the left view is a view in which the left side of the action robot 42 is displayed, the right view is a view in which the right side of the action robot 42 is displayed, the top view is a view in which the top of the action robot 42 is displayed, the bottom view is s view in which the bottom of the action robot 42 is displayed, and the perspective view is a view in which an internal joint of the action robot 42 is revealed.

The controller 210 may change a display method of the action robot simulation 1105 to at least one of the front view, the rear view, the left view, the right view, the top view, the bottom view, and the perspective view each time the multi-view icon 1109 is selected. The controller 210 may change the display method of the action robot simulation 1105 in the order of the front view, the rear view, the left view, the right view, the top view, the bottom view, and the perspective view each time the multi-view icon 1109 is selected. However, the order is only exemplary and may be changed or a specific view may be omitted or added.

In addition, the controller 210 may display the action robot simulation 1105 in a perspective view when receiving a perspective view change command. For example, when receiving the perspective view change command in the state in which the action robot simulation 1105 is displayed in the front view, the controller 210 may display the action robot simulation 1105 in a front perspective view in which the internal joint of the action robot 42 is exposed in the front view state. When receiving the perspective view change command in a state in which the action robot simulation 1105 is displayed in the left view, the controller 210 may display the action robot simulation 1105 in a left perspective view in which the internal joint of the action robot 42 is exposed in the left view state. Similarly, the controller 210 may perform change to a perspective view in which the internal joint of the action robot 42 is exposed in the current view state when receiving the perspective view switch command in the state of being displayed in the rear view, the right view, the top view, or the bottom view. In another example, the perspective view switch command may be a command to select and drag two points on the action robot simulation 1105, which is merely an example.

In addition, the controller 210 may display the action robot simulation 1105 in a front view when receiving a view return command. For example, the controller 210 may display the action robot simulation 1105 in the front view when receiving a view return command in a state in which the action robot simulation 1105 being displayed in the rear view, the left view, the right view, the top view, the bottom view, or perspective view. In another example, the view return command may be a command (double tap) to select the action robot simulation 1105 twice in succession, which is merely exemplary.

In addition, the controller 210 may switch the display method of the action robot simulation 1105 in response to reception of a swipe command to select a point on the action robot simulation 1105 and drag the same in a predetermined direction. For example, the controller 210 may display the action robot simulation 1105 in the right view when receiving a swipe command of selecting a point on the action robot simulation 1105 displayed in the front view and dragging the same to the right side, and display the action robot simulation 1105 in the rear view when receiving a swipe command of selecting a point on the action robot simulation 1105 displayed in the right view and dragging the same to the right side. As described above, when the controller 210 receives a swipe command of selecting a point on the action robot simulation 1105 and dragging the same in a predetermined direction, the controller 210 may rotate the action robot simulation 1105 at a certain angle in a range of from 0 degrees to 360 degrees and display the action robot simulation 1105.

The motion effect icon 1110 may be an icon for setting a motion effect of the action robot 42. The motion effect icon 1110 may include at least one of an invert icon 1111, a speed icon 1113, and a reverse icon 1115. However, the motion effect icon 1110 shown in FIG. 9 is merely exemplary, and some motion icons may be omitted or may be further included.

The motion effect icon 1110 may be an icon for applying a motion effect to at least one motion part data which is set through the motion setting icon 1120. The controller 210 may receive a selection command for the motion effect icon 1110 in a state in which at least one of the motion part data set through the motion setting icon 1120 is selected. The invert icon 1111 is an icon for inverting the motion of the action robot 42 and may be an icon for inverting and storing the motion part data. When the controller 210 receives a selection command for the invert icon 1111, the controller 210 may store the motion part data selected in the motion setting icon 1120 by inverting the motion part data left and right or upside down.

The speed icon 1113 is an icon for setting a motion speed of the action robot 42 and may be an icon for setting a speed value of the motion part data. When the controller 210 receives the selection command for the speed icon 1113, the controller 210 may set the speed value of the motion part data selected in the motion setting icon 1120 to any one of 0.2×, 0.5×, 1×, 2×, or 4×.

The reverse icon 1115 may be an icon for performing settings to perform the motion of the action robot 42 in a reverse direction. When the controller 210 receives a selection command for the reverse icon 1115, the controller 210 may perform settings to perform the motion of the motion part data selected in the motion setting icon 1120 in a reverse direction. For example, when the controller 210 receives a selection command for the reverse icon 1115 in a state in which the motion part data for raising a left arm is selected, the controller 210 may change the motion part data to motion part data for lowering the left arm.

The duration icon 1117 may be an icon for setting a duration of a specific motion. The duration icon 1117 may be an icon for setting a motion duration of at least one motion part data which is set through the motion setting icon 1120. The motion setting icon 1120 is an icon for generating at least one motion part data, and the controller 210 may generate motion part data through the motion setting icon 1120. The motion part data may be data for controlling each motion part of the action robot 42.

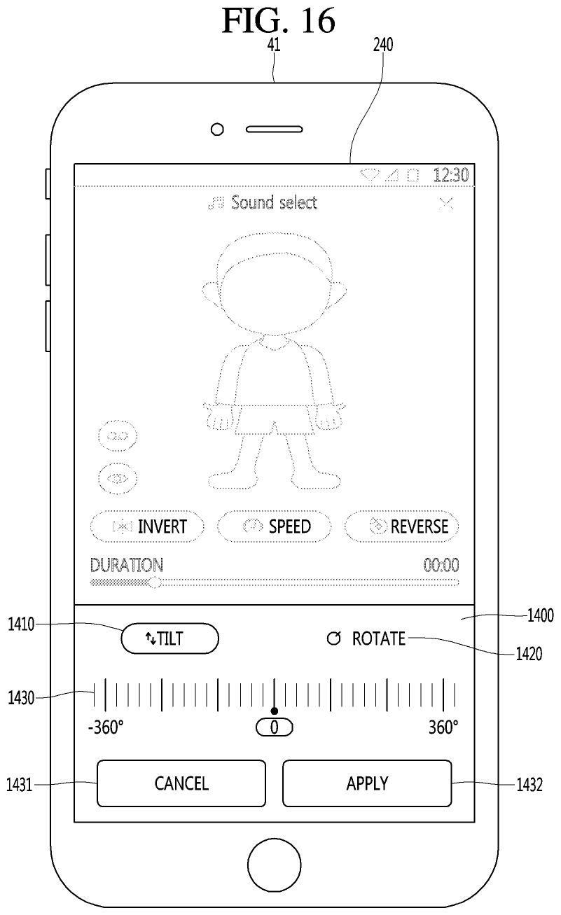

The motion data may be composed of a combination of pieces of motion part data. The motion data may include a plurality of pieces of motion part data and motion times at which the plurality of pieces of motion part data are respectively expressed. The controller 210 may generate motion data by setting a motion time for each of the plurality of pieces of motion part data. A method of generating motion part data through the motion setting icon 1120 will be described later with reference to FIG. 15.

The motion production option icon 1123 may be an icon for extracting motion data. The motion production option icon 1123 may be an icon for extracting motion data from a previously-produced video or extracting motion data through video shooting. A user may produce motion data through the motion production option icon 1123 without generating pieces of motion part data.

The controller 210 may display the motion production option icon 1123 only when there is no motion part data generated in the motion setting icon 1120. When at least one motion part data is generated through the motion setting icon 1120, the controller 210 may remove the motion production option icon 1123 and display a motion storage icon 1340 (see FIG. 15).

Referring back to FIG. 7, the controller 210 may determine whether a selection command for a motion loading icon 1101 is received in a state in which the motion production screen 1100 is displayed (S17). When the controller 210 receives the selection command for the motion loading icon 1101, the controller 210 may load the motion data so as to edit previously-produced motion data. A description for a method of editing the previously-produced motion data will be described later through steps S25 to S33. Otherwise, when the controller 210 does not receive the selection command for the motion loading icon 1101 on the motion production screen 1100, the controller 210 may determine whether a motion extraction command is received (S18). When the controller 210 receives the motion extraction command, the controller 210 may extract motion data from a video (S19).

For example, the controller 210 may recognize the selection command for the motion production option icon 1123 (see FIG. 9) as the motion extraction command on the motion production screen 1100. Accordingly, the controller 210 may determine that the motion extraction command is received when the selection command for the motion production option icon 1123 is received.

As previously described, the motion production option icon 1123 may include a video shooting motion production icon 1124 and a video selection motion production icon 1125. The video shooting motion production icon 1124 may be an icon for shooting a video in real time and extracting motion data by detecting movement of an object (e.g., a person or an animal) included in the shot video. The video selection motion production icon 1125 may be an icon for selecting a previously-produced video and extracting motion data by detecting a movement of an object (e.g., a person or an animal) included in the selected video.

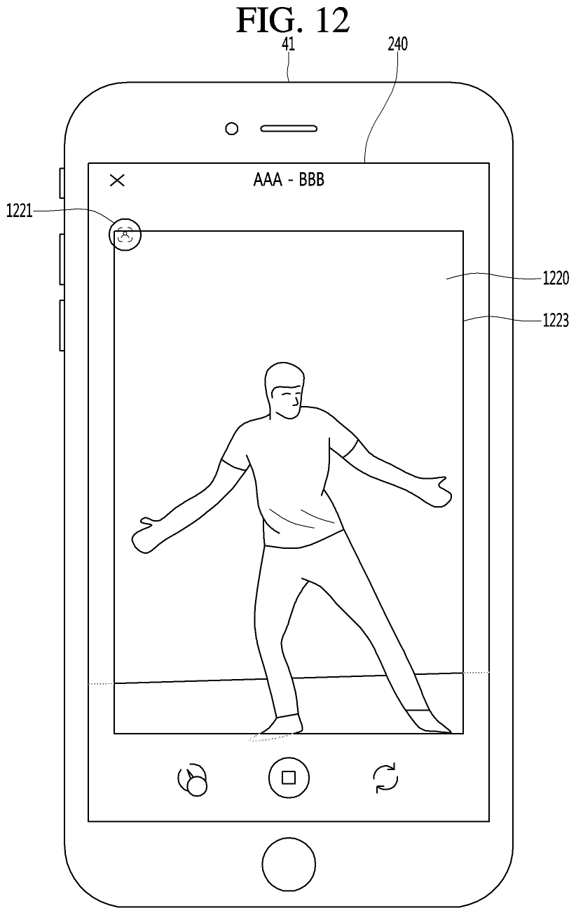

Hereinafter, a method of extracting motion data from a video upon receiving a motion extraction command will be described. The method of extracting motion through video shooting according to an embodiment of the present disclosure will be described with reference to FIGS. 10 to 12. For example, FIG. 10 provides an exemplary view of a shooting guide screen displayed when a motion is extracted through video shooting according to an embodiment of the present disclosure.

The controller 210 may display a shooting guide screen 1210 before displaying the video shooting screen when receiving a selection command for the video shooting motion production icon 1124 on the motion production screen 1100. The shooting guide screen 1210 may be a screen for guiding a video shooting method to facilitate motion extraction from the video. For example, the shooting guide screen 1210 may include a message for fixing movement of a camera, a message for guiding a location of an object such as a person, a message for guiding a brightness of a background and an object, and the like.

According to an embodiment, the controller 210 may display the shooting guide screen 1210 each time a selection command for the video shooting motion production icon 1124 is received. According to another embodiment, the controller 210 may display the shooting guide screen 1210 only when a selection command for the video shooting motion production icon 1124 is initially received. According to still another embodiment, the controller 210 may omit the display of the shooting guide screen 1210.

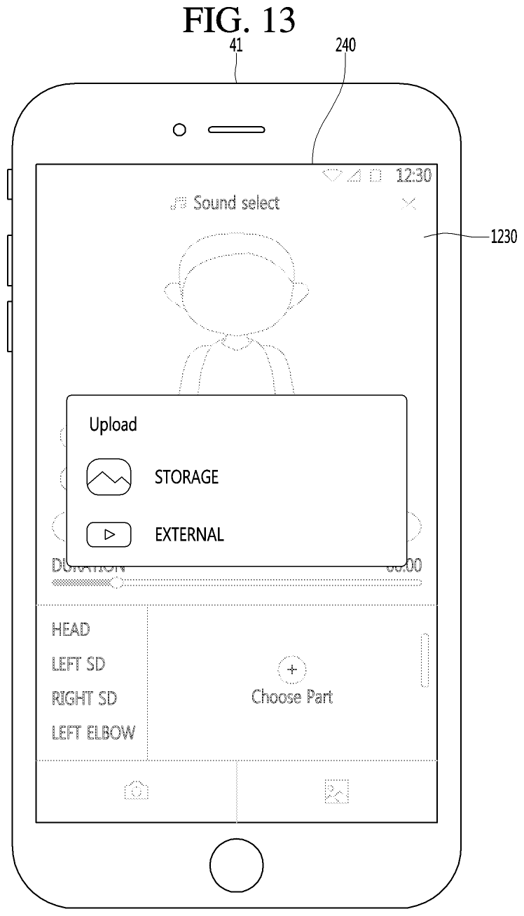

FIGS. 11 to 12 illustrate examples of a video shooting screen in the case of motion extraction through video shooting according to an embodiment of the present disclosure. The controller 210 may display a video shooting screen 1220 for motion extraction, and the video shooting screen 1220 may include a guide function on/off icon 1221. The guide function on/off icon 1221 is an icon for turning on or off a guide function. The guide function may be a function of guiding a joint position of an object being recognized to extract motion data from a video which is being shot. The controller 210 may be turned on or off whenever a selection command for the guide function on/off icon 1221 is received.

When the guide function is turned on, the controller 210 may display at least one guide icon 1222 on the video shooting screen 1220. The guide icon 1222 may be displayed at the joint position of the object being recognized to extract motion data, such as positioning the guide icons 1222 at locations of a dancer corresponding to the moving parts of the robot. In one example, the controller 210 may automatically identify with guide icons 1222 sections of a recorded dancer associated with movement, such as joints (e.g., a neck, shoulder, elbow, wrists, waist knees, ankles etc.), and then determine actual motion during the dance at the regions associated with the guide icons to determine robot motion data to mimic the dance. For instance, the controller 210 may evaluation changes in the positions of the guide icons 1222 over time to determine a motion at each of the joints, and determine the timing the motions with respect to the multimedia content, and then form motion data for the robot that corresponds to the actual movement of the dancer's joints. The video shooting screen 1220 illustrated in FIG. 11 corresponds to a case where a guide function is turned on, so that the video shooting screen 1220 may include at least one guide icon 1222. The video shooting screen 1220 illustrated in FIG. 12 corresponds to a case where the function is turned off, so that the guide icon 1222 may not be displayed on the video shooting screen 1220.

As illustrated in FIG. 12, the video shooting screen 1220 may further include a guide box 1223. The guide box 1223 may be displayed to minimize a case in which some joints of the object are not shot because the object is out of a video shooting range. The size of the guide box 1223 may be narrower than the size of the video shooting range.

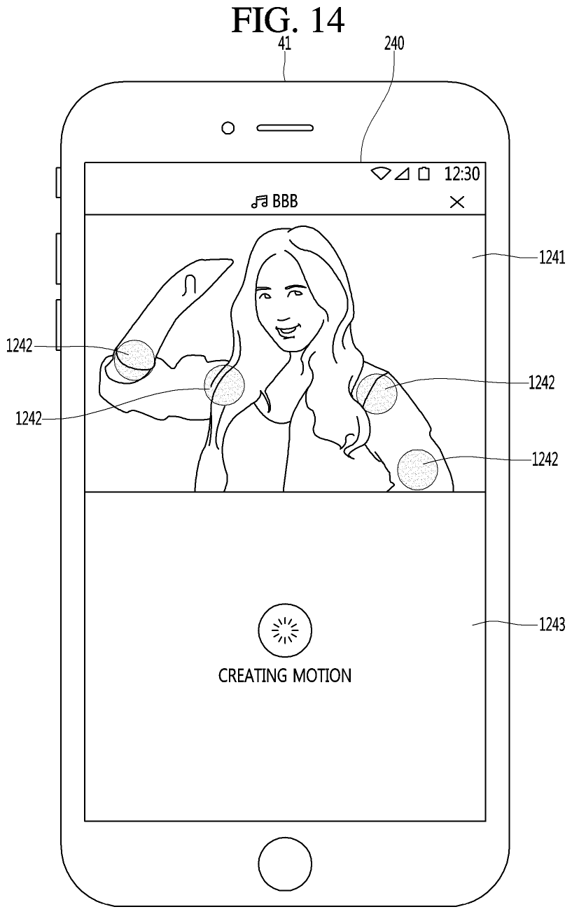

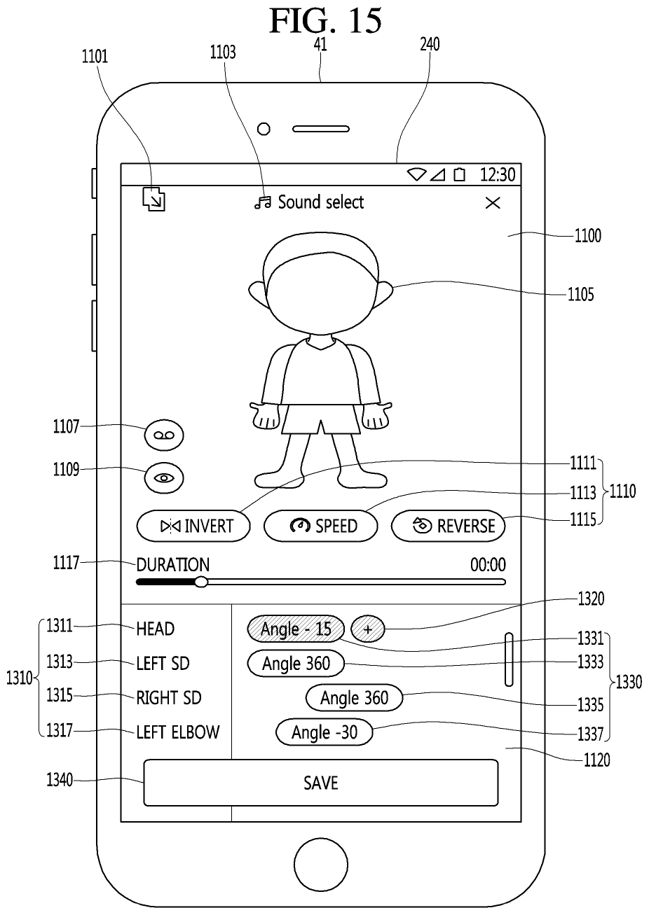

Next, a motion extraction method through video selection according to an embodiment of the present disclosure will be described with reference to FIGS. 13 to 14. FIG. 13 is a view illustrating an example of a video location selection screen according to an embodiment of the present disclosure, and FIG. 14 is a view illustrating an example of a video motion extraction screen according to an embodiment of the present disclosure.

The controller 210 may display the video location selection screen 1230 as shown in FIG. 13 when a selection command for the video selection motion production icon 1125 is received. The video location selection screen 1230 may be a screen for selecting a storage location of a video for motion extraction. For example, the video location selection screen 1230 may include a ‘memory’ icon and an ‘outside’ icon, and the controller 210 may display a video stored in the terminal 41 when a selection command for the ‘memory’ icon is received and display a video that may be received through an external server, another application or the like when a selection command for the ‘outside’ icon is received. However, FIG. 13 is merely an example, and the video location selection screen 1230 may include an application list for providing a video.

The controller 210 may select a video stored in the terminal 41 or a video that may be received from the outside. The controller 210 may extract motion data from the selected video, and display a video motion extraction screen 1240 as illustrated in FIG. 14. The video motion extraction screen 1240 may include a video 1241 selected for motion extraction and extraction motion information 1243. The extraction motion information 1243 may include a motion part extracted from the selected video 1241 and a motion value such as an angle associated with the motion. In addition, the extraction motion information 1243 may include a guide for providing guidance representing that the motion is being generated when the motion is extracted. The selected video 1241 may further include at least one guide icon 1242 representing the joint position of the object which is recognized in the video. The guide icon 1242 may correspond to the guide icon 1222.

Referring again to FIG. 7, when the controller 210 does not receive a motion extraction command, the controller 210 may receive a generation command for motion part data (S20). The generation command for the motion part data may be a command for setting each motion of the action robot 42. The generation command for the motion part data may be a command for generating motion part data constituting the motion data.

The motion part data may include at least one of a part of motion, a value of motion, and a motion time. Hereinafter, the motion part may refer to a part that can be driven by an actuator module provided in the action robot 42 and may include a joint that is moved by actuation of a motor or the like. The motion value may include at least one of a tilt angle or a rotation angle. The motion time may refer to a time for which the actuator module of the action robot 42 is driven according to the motion part data. The controller 210 may receive motion part data including at least one of a motion part controlled to move in the action robot 42, a tilt angle of the motion part, and a rotation angle of the motion part.

FIG. 15 is an exemplary diagram illustrating how the motion production screen 1100 may be used in a method of receiving, by the terminal, a generation command for motion part data according to an embodiment of the present disclosure. The controller 210 may receive a generation command for motion part data through the motion setting icon 1120. The motion setting icon 1120 may include at least one of a motion part selection icon 1310, a motion addition icon 1320, and a motion information icon 1330.

The motion part selection icon 1310 may be an icon for selecting a part to move in the action robot 42. The part to move in the action robot 42 may mean a part, a joint, or the like of the action robot 42, and may include, for example, a head, a left shoulder, a left elbow, a right shoulder, a right elbow, and the like.

For example, the motion part selection icon 1310 may include a first motion part 1311, a second motion part 1313, a third motion part 1315, and a fourth motion part 1317. The first motion part 1311 may mean the head of the action robot 42, the second motion part 1313 may mean the left shoulder of the action robot 42, the third motion part 1315 may mean the right shoulder of the action robot 42, and the fourth motion part 1317 may mean the left elbow of the action robot 42. Although only the first to fourth motion parts 1311, 1313, 1315, and 1317 are shown in FIG. 15, these are for convenience of description, and the motion part selection icon 1310 may include a motion part representing more portions or joints of the action robot 42 when a scroll bar is moved.

When the controller 210 receives a command for selecting at least one of the first to fourth motion parts 1311, 1313, 1315, and 1317, the controller 210 may display a motion addition icon 1320 corresponding to the selected motion part. For example, as illustrated in FIG. 15, when the controller 210 receives a selection command for the first motion part 1311, the controller 210 may display the motion addition icon 1320 corresponding to the first motion part 1311. The motion addition icon 1320 may be an icon for setting a motion value in the selected part. The controller 210 may display a motion value setting screen when a selection command for the motion addition icon 1320 is received.

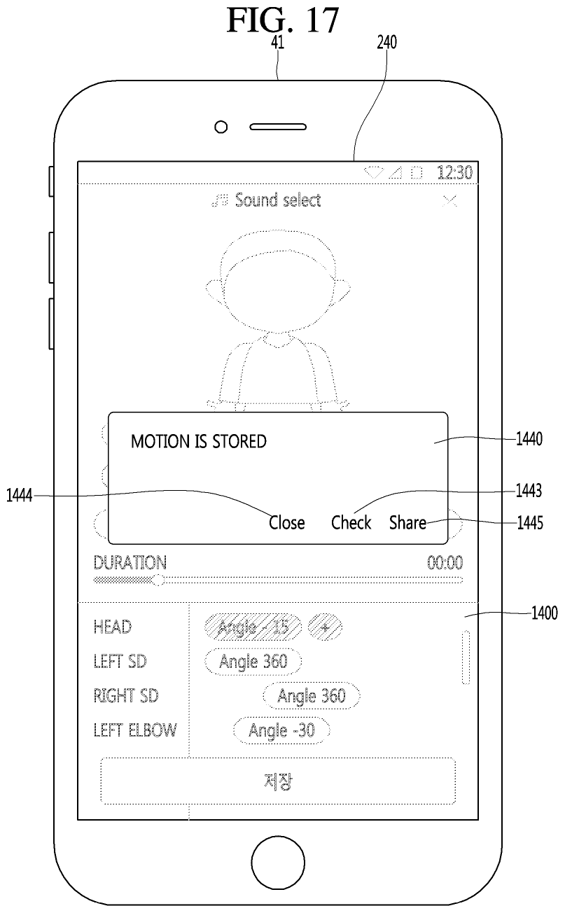

FIG. 16 is an exemplary diagram of a motion value setting screen 1400 according to an embodiment of the present disclosure. The controller 210 may display the motion value setting screen 1400 as shown in FIG. 16 when receiving the selection command for the motion addition icon 1320. The motion value setting screen 1400 may include at least one of a tilt icon 1410, a rotate icon 1420, a number selection icon 1430, a cancel icon 1431, and an application icon 1432.

The tilt icon 1410 may be an icon for setting the tilt angle of a selected part. When the controller 210 receives a command for selecting a specific value through the number selection icon 1430 in a state in which the tilt icon 1410 is selected, the controller 210 may generate motion part data that controls the selected part so as to be moved by a selected value in a vertical direction.

The rotate icon 1420 may be an icon for setting a rotation angle of the selected part. When the controller 210 receives a command for selecting a specific value through the number selection icon 1430 in a state in which the rotate icon 1420 is selected, the controller 210 may generate motion part data that controls the selected part so as to be rotated by a selected value in a horizontal direction. For example, the controller 210 may generate motion part data which is driven at least in the vertical direction or the horizontal direction through the tilt icon 1410 and the rotate icon 1420.

The number selection icon 1430 may include angle information for setting the tilt angle in the vertical direction or the rotation angle in the horizontal direction. The cancel icon 1431 may be an icon for canceling generation of motion part data. The application icon 1432 may be an icon for generating motion part data. When the controller 210 receives a selection command for the application icon 1432, the controller 210 may generate motion part data including a motion value set through at least one of the tilt icon 1410 and the rotate icon 1420. When the controller 210 receives the selection command for the application icon 1432, the controller 210 may display a motion information icon 1330 including a motion part and a motion value.

When generating the motion part data, the controller 210 may display the motion information icon 1330 according to the motion part data on the motion setting icon 1120. For example, the motion information icon 1330 may correspond to motion part data. When the controller 210 generates a plurality of motion part data, the controller 210 may display a motion information icon 1330 representing each of a plurality of pieces of motion part data.

When the controller 210 displays the plurality of motion information icons 1330, the controller 210 may display the plurality of motion information icons 1330 with time. In detail, each of the pieces of motion part data may include a motion time for which the action robot 42 is driven, and the controller 210 may display the motion information icon 1330 according to the motion time. That is, the controller 210 may display the motion information icon 1330 on the left side as the motion time of the motion part data is faster, and display the motion information icon 1330 on the right side as the motion time of the motion part data is slower. For example, the motion information icon 1330 may include a first motion information icon 1331, a second motion information icon 1333, a third motion information icon 1335, and a fourth motion information icon 1357.

The motion time of the first motion information icon 1331 and the second motion information icon 1333 may be 00:00, the motion time of the third motion information icon 1335 may be 01:00, and the fourth motion information icon 1335 may be 00:30. In this case, the controller 210 may display the first motion information icon 1331 and the second motion information icon 1333 on the leftmost side, the third motion information icon 1335 on the rightmost side, and the fourth motion information icon 1357 between the first and second motion information icons 1331 and 1333 and the third motion information icon 1335.

The motion information icon 1330 is displayed at a position corresponding to the motion part and may include motion value information. When the controller 210 receives the selection command for the motion information icon 1330, the controller 210 may again display the motion value setting screen 1400 to change a motion value. In addition, the controller 210 may receive a command for changing at least one of a motion part and a motion time through a command for dragging and dropping the motion information icon 1330.

The controller 210 may receive a selection command for a storage icon 1340 after at least one piece of motion part data is generated. The storage icon 1340 may be an icon for generating motion data composed of pieces of motion part data displayed on the motion setting icon 1120. When the controller 210 receives the selection command for the storage icon 1340, the controller 210 may recognize that a motion generation command has been received. When the controller 210 receives the motion generation command, the controller 210 may generate motion data including at least one piece of motion part data generated through the motion setting icon 1120.

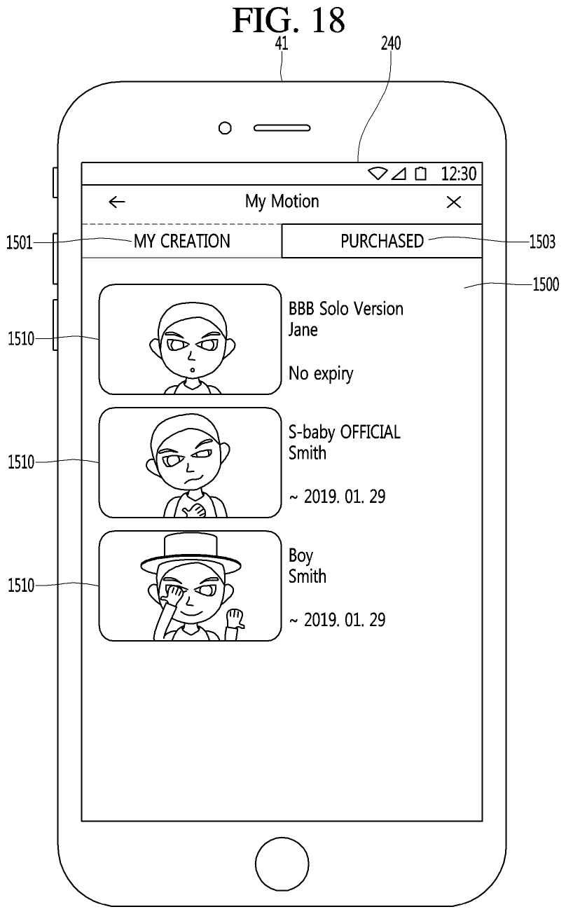

FIG. 17 is an exemplary diagram of the motion data generation screen 1400 according to an embodiment of the present disclosure. The controller 210 may display a motion data generation screen 1400 as illustrated in FIG. 17 when generating motion data. As shown in FIG. 17, the motion data generation screen 1400 may include a storage completion message 1440. The storage completion message 1440 may be a message indicating that the generation of the motion data is normally completed.

The storage completion message 1440 may include at least one of a close icon 1444, a check icon 1443, and a share icon 1445. The close icon 1444 may be an icon for confirming completion of generation of the motion data and may be an icon for ending generation of the motion data. The check icon 1443 may be an icon for checking the motion of the action robot 42 according to the generated motion data. When the controller 210 receives a selection command for the check icon 1443, the controller 210 may display an icon (not shown) for receiving a selection of whether to check the motion of the action robot 42 through the application or whether to check the motion data through the action robot 42. When the controller 210 receives the selection command for the check icon 1443, the controller 210 may display a motion of the action robot 42 according to the generated motion data on the application and perform control such that the action robot 42 moves according to the motion data. The share icon 1445 may be an icon for sharing the generated motion data with other users. The controller 210 may transmit the generated motion data to the operating device 100 or another user when receiving the selection command for the share icon 1445.

Referring again to FIG. 7, after receiving a generation command for the motion part data, the controller 210 may determine whether a motion generation command is received (S21). As described above, when receiving the motion generation command, the controller 210 may generate motion data composed of pieces of motion part data (S22). On the other hand, the terminal according to an embodiment of the present disclosure may edit previously-produced motion data. In step S17 of FIG. 7, when the controller 210 receives a selection command for the motion loading icon 1101, the controller 210 may display a motion list (S25).

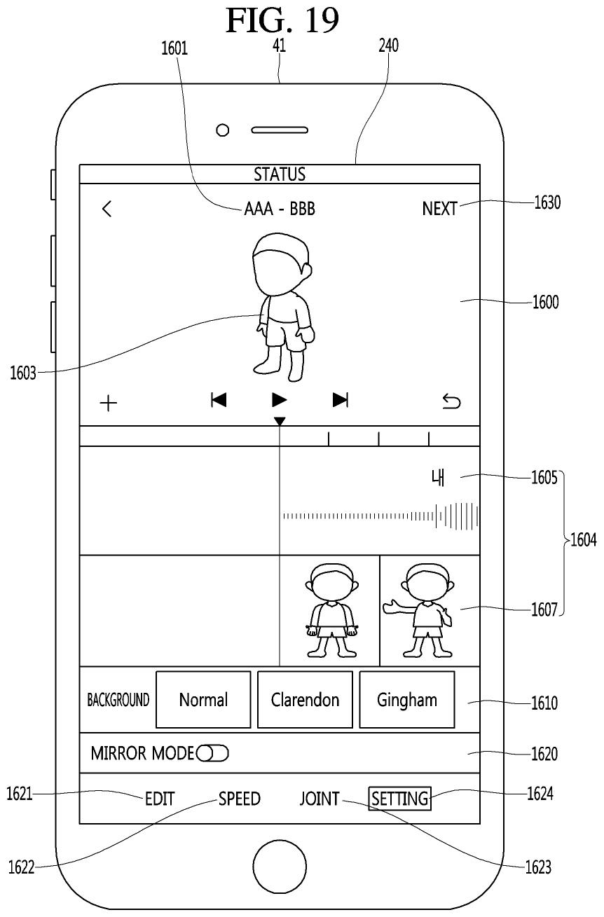

FIG. 18 is a diagram illustrating a method for displaying a motion list 1500 by a terminal according to an embodiment of the present disclosure. For example, the controller 210 may display a motion list 1500 on the display 240. The motion list 1500 may include a motion data item 1510 representing motion data held by a user through the terminal 41 or the action robot 42. The motion list 1500 may include at least one motion data item 1510.

When displaying the motion list 1500, the controller 210 may display user-generated motion data and user-purchased motion data to be distinguished from each other. For example, the motion list 1500 may include a production tab 1501 and a purchase tab 1503. When the controller 210 receives the selection command for the production tab 1501, the controller 210 may display a motion data item representing motion data produced based on at least one of a motion generation command, a motion extraction command, and a motion editing command. When the controller 210 receives a selection command for the purchase tab 1503, the controller 210 may display a motion data item 1510 representing motion data purchased through the operating device 100. The motion data item 1510 may include at least one of a motion thumbnail, a content name, an artist name, and an expiration date. The controller 210 may receive a command for selecting any one of at least one motion data item 1510 included in the motion list 1500.

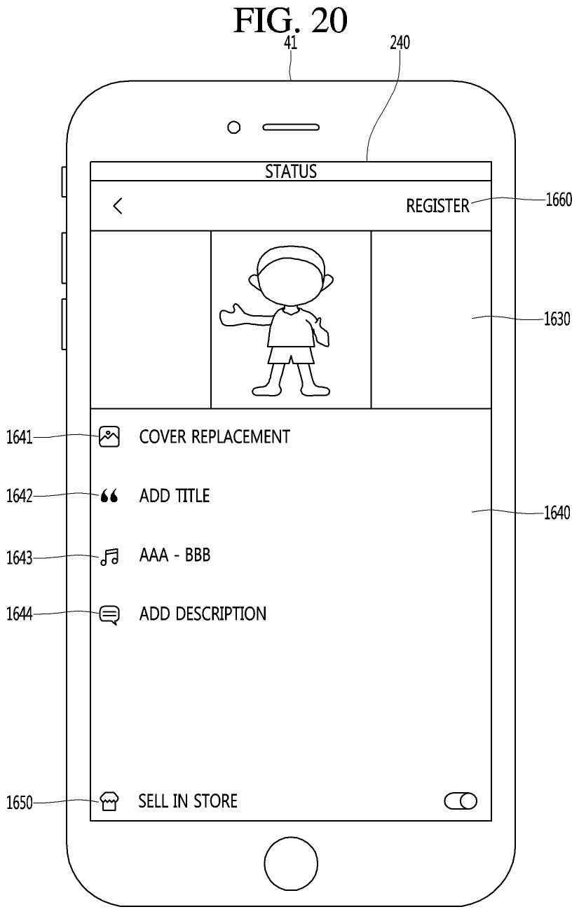

Referring back to FIG. 7, the controller 210 may display a motion editing screen 1600 (see FIG. 19) of the motion data selected from the motion list 1500 (S27). The controller 210 may receive at least one motion editing command through the motion editing screen 1600 (S29). The controller 210 may determine whether a motion editing complete command is received (S31), and receive a motion editing command until the motion editing complete command is received. When the controller 210 receives the motion editing completion command, the controller 210 may change the motion data according to the motion editing command (S33).

Next, a method of receiving a motion editing command through a motion editing screen 1600 will be described with reference to FIGS. 19 to 20. FIGS. 19 to 20 are exemplary diagrams of a motion editing screen 1600 according to an embodiment of the present disclosure. The controller 210 may display the motion editing screen 1600, and the motion editing screen 1600 may be a screen for editing at least a part of previously-produced motion data. The motion editing command may include all commands received through the motion editing screen.

The motion editing screen 1600 may display at least one of multimedia content information 1601, an action robot rendering image 1603, content synchronization information 1604, a background option item 1610, a mirror mode item 1620, an editing icon 1621, a speed icon 1622, a joint icon 1623, and a setting icon 1624. For example, the background option item 1621 and the mirror mode item 1620 may be items displayed as the setting icon 1624 is selected. The controller 210 may display an item other than the background option item 1621 and the mirror mode item 1620 when the speed icon 1622 or the joint icon 1623 is selected instead of the setting icon 1624.

The multimedia content information 1601 may be information on content to be played together with motion data. For example, when content played with the motion data is music content, the multimedia content information 1601 may include a sound source name and an artist name. As another example, when content played with the motion data is fairy tale content, the multimedia content information 1601 may include a fairy tale name and an author's name.

The action robot rendering image 1603 may be an image in which a motion of the action robot 42 according to the motion data is displayed in three dimensions The user may check a motion of the action robot 42 according to selected motion data and a motion of the action robot 42 according to edited motion data through the action robot rendering image 1603.

The content synchronization information 1604 may include playback information 1605 of the multimedia content and playback information 1607 of the motion data, and the playback information 1605 of the multimedia content and the playback information 1067 of the motion data may be displayed side by side with the same playback time point as a reference. The playback information 1605 of the multimedia content may include song lyrics, a sound volume, and the like, and the playback information 1067 of the motion data may include a motion of the action robot 42.

The background option item 1610 may be an item for selecting a background on which the motion of the action robot 42 is played. The controller 210 may set a background selected in the background option item 1610 as the background of the action robot rendering image 1603.

The mirror mode item 1620 may be an item for displaying the motion of the action robot 42 in the mirror. The controller 210 may display the appearance of the action robot 42 in the action robot rendering image 1603 in the actual mode or in the mirror mode in accordance with whether a mirror mode is turned on or off in the mirror mode item 1620.

The editing icon 1621 may be an icon for changing multimedia content or the motion content. The speed icon 1622 may be an icon for adjusting a motion speed of the action robot 42. The speed icon 1622 may enable editing of a speed of each motion part data constituting the motion data. The joint icon 1623 may be an icon for changing a motion portion of the action robot 42. The speed icon 1622 may enable change of motion part of each motion part data constituting the motion data. The setting icon 1624 is an icon for setting an additional effect in motion data of the action robot 42 and may include the background option item 1610 and the mirror mode item 1620 as illustrated in FIG. 19, but is only an example and is not limited thereto.

The motion editing screen 1600 may further include a next icon 1630. The controller 210 may display a cover editing screen 1640 when receiving a selection command for the next icon 1630. The cover editing screen 1640 is a screen for editing a cover of the edited motion data, and may include at least one of a cover preview image 1630, a cover replacement item 1641, a title addition item 1644, a multimedia content item 1643, and a description additional item 1644 and a store selling item 1650.

The cover of the motion data may mean summary information of the motion data displayed on the motion list 1600 or summary information of the motion data to be sold through the operating device 100. For example, the cover preview image 1630 may be an image in which the action robot 42 moves according to the motion data. The cover preview image 1630 may be a still image or a short image whose a play time is within a preset time (e.g., 10 seconds).

The cover preview image 1630 may be changed through the cover replacement item 1641. When the cover replacement item 1641 is selected, the controller 210 may display a simulation image in which the action robot 42 moves according to the motion data, and set the cover preview image through a command for selecting at least a part of the simulation image.

The title addition item 1642 may be an item for setting a title representing multimedia content and motion data. The user may set a title to be displayed on the cover of the motion data through the title addition item 1642. The multimedia content item 1643 may be an item on which information of the multimedia content is displayed. The description addition item 1644 may be an item for setting description information for the multimedia content and the motion data. The user may set description information to be displayed on the cover of the motion data through the description addition item 1644.

The store selling item 1650 may be an item for setting whether to upload the motion data to an application store such that the motion data that is being edited is able to be sold. The controller 210 may receive a setting command for a selling on/off function through the store selling item 1650. The controller 210 may upload edited motion data to the application store such that the edited motion data may be sold through the operating device 100 when the selling on function is set. On the other hand, when the selling off function is set, the controller 210 may not upload the edited motion data to the application store.

The cover editing screen 1640 may further include a registration icon 1660. When the controller 210 receives a selection command for the registration icon 1660, the controller 210 may change the motion data based on the motion editing command received through the motion editing screen 1600 and the cover editing screen 1640.

The cover editing screen 1640 may be a part of the motion editing screen 1600. The cover editing screen 1640 may be separately displayed by the size of the display 240, and the cover editing screen 1640 may be included in the motion editing screen 1600.

Referring to FIG. 7, the motion editing command may include a command received through the cover editing screen 1640 and the motion editing screen 1600, and the motion editing completion command may include a selection command for the registration icon 1660 included in the cover editing screen 1640 or the motion editing screen 1600. In step S13, when a selection command for the motion addition icon is not received, the controller 210 may determine whether at least one of a motion purchase command and a motion selling command is received. For example, the controller 210 may determine whether a motion purchase command has been received (S35), and when receiving a motion purchase command, transmit a motion purchase request signal to the operating device 100 (S37).

The controller 210 may receive the motion purchase command for at least one piece of motion data on an application. For example, the controller 210 may receive the motion purchase command for at least one piece of motion data through a store screen 1700 (see FIG. 21). A method of receiving a motion purchase command by a terminal according to an embodiment of the present disclosure will be described with reference to FIGS. 21 through 22.

FIG. 21 is an exemplary view of a store screen 1700 of action robot content according to an embodiment of the present disclosure. The controller 210 may display the store screen 1700. For example, the controller 210 may display the store screen 1700 as a selection command for a content icon 1060 is received through a home screen 1000 of the application.

The store screen 1700 may include at least one of a music tab 1710, an action tab 1720, a popularity tab 1730, a style tab 1740, and a content list. For example, the content list may include at least one of multimedia content and motion data.

The music tab 1710 may be for providing only purchasable multimedia content (e.g., a sound source). When the controller 210 receives a selection command for the music tab 1710, the controller 210 may display a content list including multimedia contents that can be purchased.

The action tab 1720 may be for providing only a list of purchasable motion data. When the controller 210 receives a selection command for the action tab 1720, the controller 210 may display a content list including purchasable motion data.

The popularity tab 1730 may be used to provide multimedia content and motion data whose number of purchases is greater than or equal to a reference number. When the controller 210 receives a selection command for the popularity tap 1730, the controller 210 may display a content list including multimedia content and motion data whose the number of purchases is greater than or equal to a reference number.

The style tab 1740 may be used to classify and provide motion data according to a motion style. The motion data may be classified into a plurality of motion methods according to a motion part, a motion speed, a motion angle, and the like. That is, the motion data may be classified into a plurality of motion methods, similar to a case in which sound sources are classified into a plurality of genres such as dance and ballad. When the controller 210 receives a selection command for the style tab 1740, the controller 210 may classify the purchasable motion data into a plurality of motion methods and display a content list.

The content list may include first to sixth content items 1701 to 1706 representing multimedia content or motion data. In FIG. 21, six content items are illustrated, but this particular quantity is exemplary and the store screen 1700 is not limited thereto. The controller 210 may receive a selection command for any one of the first to sixth content items 1701 to 1706, and when the selection command for one content item is received, display a content detail screen 1800 corresponding to a selected content item.

FIG. 22 is an exemplary view of a content detail screen 1800 according to an embodiment of the present disclosure. For example, the controller 210 may display the content detail screen 1800 as illustrated in FIG. 22. The content detail screen 1800 may include information on content data and a purchase icon 1801. The information on the content data refers to information on at least one of the multimedia content and the motion data, and may include at least one of a cover image, a content name, an artist name, a price, a genre, a style, and similar content.

The purchase icon 1801 may be an icon for providing a function of purchasing motion data in which movement of the action robot 42 is set according to playback of the multimedia content. The purchase icon 1801 may be for requesting a purchase of content data being displayed through the content detail screen 1800. When the controller 210 receives the selection command for the purchase icon 1801, the controller 210 may recognize that the motion purchase command has been received, and transmit a motion purchase request signal to the operating device 100.

When the operating device 100 receives the motion purchase request signal, the operating device 100 may transmit content data corresponding to the motion purchase request signal to the terminal 41 or the action robot 42 connected to the terminal 41. The content data may include at least one of multimedia content and motion data. When the terminal 41 receives the content data, the terminal 41 may transmit the received content data to the action robot 42 connected to the terminal 41. The action robot 42 may store the received content data.

Meanwhile, as another example, when the controller 210 receives a command for selecting at least one of the motion update information 1030 of the home screen 1000 (see FIG. 8), the controller 210 may display the content detail screen 1800 as illustrated in FIG. 22. However, the above-described method is merely an example for convenience of description, and the controller 210 may receive a motion purchase command in various ways through an application.

Referring again to FIG. 7, the controller 210 may determine whether a motion selling command is received (S39), and when receiving the motion selling command, may transmit a motion selling request signal to the operating device 100 (S41). The controller 210 may receive a motion selling command for at least one motion data on the application. The motion selling command may be a command for selling at least one motion data stored in the terminal 41 or the action robot 42 to at least one of the content provider 20, the motion data producer 30, and the user 40.

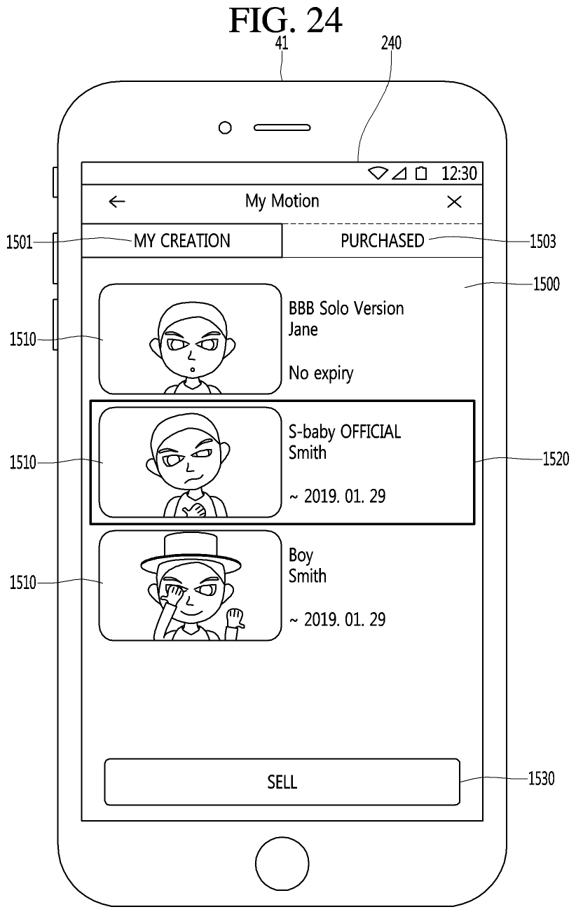

Thereafter, a method of receiving a motion selling command by a terminal according to an embodiment of the present disclosure will be described with reference to FIGS. 23 to 24. FIG. 23 is an exemplary view of a user account screen 1900 according to an embodiment of the present disclosure. The controller 210 may display a user account screen 1900. For example, the controller 210 may display the user account screen 1900 as a selection command for the user icon 109 is received through the home screen 1000 of the application.

The user account screen 1900 may include at least one of user information 1901, a my motion icon 1902, a gift box icon 1903, and a like icon 1904. The user information 1901 may include account information of a user who is logged in to the application. The user account information may include a user ID and action robot information associated with the user ID.

The my motion icon 1902 may be an icon for displaying multimedia content and motion data which are held by the user. When the controller 210 receives a selection command for the my motion icon 1902, the controller 210 may display a motion list 1500 including at least one of multimedia content and motion data, which are stored, through at least one of the terminal 41 and the action robot 42.

The gift box icon 1903 may be an icon for displaying multimedia content and motion data received from another user or the operating device 100. When the controller 210 receives a selection command for the gift box icon 1903, the controller 210 may display at least one of multimedia content and motion data received from another user or the operating device 100.

The like icon 1904 may be an icon for displaying multimedia content and motion data marked by a user through an application. When the controller 210 receives a selection command for the like icon 1904, the controller 210 may display at least one of multimedia content and motion data which are previously marked.

FIG. 24 is an exemplary view for describing a method of receiving a motion selling command through a motion list 1500 according to an embodiment of the present disclosure. The controller 210 may receive a selection command for at least one motion data item 1510 displayed in the motion list 1500.

When any one motion data item 1510 is selected in the motion list 1500, the controller 210 may display a selling icon 1530 corresponding to the selected motion data item 1510. The controller 210 may display a selection mark 1520 on the selected motion data item 1510. In this case, the user can easily grasp a motion data item to be sold. The selling icon 1530 may be an icon for selling motion data of the action robot 42.

The motion data of the action robot 42 may include user-generated motion data which is generated, extracted, or edited by the user, and user-purchased motion data which is purchased by the user. The controller 210 may display the selling icon 1530 for the user-generated motion data.

When the controller 210 receives the selection command for the selling icon 1530, the controller 210 may recognize that the motion selling command has been received, and may transmit a motion selling request signal to the operating device 100. When the controller 210 receives the motion selling request signal, the controller 210 may transmit content data corresponding to the motion selling request signal to the operating device 100. The operating device 100 may perform control such that the content data according to the motion selling request signal is displayed on the store screen 1700 of the action robot content, and other users may purchase content data for which the user requests the selling through the store screen 1700 of the action robot content.

The above description is merely illustrative of the technical idea of the present disclosure, and various modifications and changes may be made thereto by those skilled in the art without departing from the essential characteristics of the present disclosure. Therefore, the embodiments of the present disclosure are not intended to limit the technical spirit of the present disclosure but to illustrate the technical idea of the present disclosure, and the technical spirit of the present disclosure is not limited by these embodiments. The scope of protection of the present disclosure should be interpreted by the appending claims, and all technical ideas within the scope of equivalents should be construed as falling within the scope of the present disclosure.

Aspects of the present disclosure provides a terminal for an action robot and a method of operating the same, which provide at least one of functions of generating, extracting, editing, selling, and purchasing motion data for controlling movement of the action robot.

A terminal according to an embodiment of the present disclosure includes a storage configured to store motion data, a wireless communicator configured to transmit the motion data to an action robot, a display configured to display a motion production screen for generating the motion data, an input interface configured to receive a command for generating pieces of motion part data for controlling motion parts of the action robot through the motion production screen respectively, and a controller configured to generate the motion data by combining the pieces of motion part data.

The controller may receive the motion part data including at least one of a motion part controlled to move in the action robot, a tilt angle of the motion part or a rotation angle of the motion part. The controller may receive a plurality of pieces of motion part data and generate the motion data by setting motion times for the plurality of pieces of motion part data. The controller may detect movement of an object included in a video and extract the motion data. The controller may display a guide icon representing a joint position of the object recognized in the video.

The controller may detect movement of the action robot connected to the terminal and generate motion data for reproducing the detected movement of the action robot. The controller is configured to display motion part data constituting one of the motion data stored in the storage and receive a motion editing command for changing at least a part of the displayed motion part data.

The controller may display a motion list including the motion data stored in the storage and display user-generated motion data and user-purchased motion data to be distinguished from each other when the motion list is displayed. The controller may further display a selling icon for selling at least one of the user-generated motion data. The controller may further display a purchase icon for motion data for setting movement of the action robot according to playback of multimedia content.

According to an embodiment of the present disclosure, it is possible to increase the ease of use of the action robot and widening the range of use by providing a user with a function of freely generating motion data. In addition, it is possible to allow a user to set movement of the action robot in detail by providing a function of setting a motion part a tilt angle, or a rotation angle, thereby setting the movement of the action robot variously. In addition, it is possible to set the motion of the action robot according to the passage of time by setting a motion time to each of pieces of motion part data, and accordingly, generate motion data of the action robot according to multimedia content such as music.

In addition, the motion data may be easily produced without setting the motion part, the tilt angle or the rotation angle by providing a function of extracting the motion data through a video or a function of directly moving the action robot to generate motion data. In addition, it is possible to allow the action robot to easily reproduce the dance of a user's favorite singer by providing a function of extracting motion data through a video. In addition, motion data trading between users is facilitated by providing a function of purchasing and selling motion data and thus, a user may easily receive a variety of motion data.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A terminal comprising:
a display configured to present a screen to receive an input related to defining a motion of a robot that includes moving parts;
an input device configured to receive the input from a user;
a controller configured to generate, based on the input, motion data to control movements of the moving parts of the robot, the motion data identifying timing of the movements by the moving parts, speeds of the movements, and at least one of a tilt angle or rotation angle associated with each of the movements;
storage configured to store the motion data; and
a wireless interface configured to transmit the motion data to the robot, the robot performing the motion based on the motion data.

2. The terminal of claim 1, wherein the controller is further configured to receive a portion of the motion data from another device, the received portion of the motion data identifying at least one of the tilt angle or the rotation angle for a movement by one of the moving parts.

3. The terminal of claim 2, wherein the controller is configured to set, based on the input, a motion time for the movement of the one of the moving parts.

4. The system of claim 1, wherein the controller is further configured to:
detect, based on the input, a movement of an object included in a video, and
extract the motion data based on the detected movement of the object included in the video.

5. The terminal of claim 4, wherein the controller is configured to control the display to present the video and an icon representing a joint position of the object in the video.

6. The terminal of claim 1, wherein the robot is a first robot, and the controller is configured to:
detect a movement of a second robot connected to the terminal, and
generate the motion data such that the first robot reproduces the detected movement of the second robot.

7. The terminal of claim 1, wherein the controller is further configured to:
control the display to provide a representation of a movement of one of the moving parts, and
modify, based on a received command, the movement of the one of the moving parts, wherein a portion of the motion data is changed to correspond to the modified movement of the one of the moving parts.

8. The terminal of claim 7, wherein the controller is further configured to: control the display to provide a representation of the modified motion of the one of the moving parts.

9. The terminal of claim 7, wherein the controller is further configured to control the display to provide a list identifying the moving parts, and to select one of the moving parts based on a user input.

10. The terminal of claim 1, wherein the controller is configured to:
control the display present a motion list identifying the motion data stored in the storage; and
control the display to distinguish, in the list, user-generated motion data and user-purchased motion data.

11. The terminal of claim 10, wherein the controller is further configured to control the display to further provide an icon that, when selected by the user, causes the terminal to provide at least a portion of the user-generated motion data to another device.

12. The system of claim 1, wherein the controller further configured to manage the display to present an icon that, when selected by the user, causes the motion data to be set according to a playback of multimedia content.

13. The terminal of claim 1, wherein the moving parts is driven by actuators in the robot, and the motion data identify driving force applied by the actuators during the movements.

14. An operating method of a terminal, comprising:
presenting, on a display of the terminal, a screen to generate motion data related to controlling a motion of a robot;
receiving, via the screen, a command to generate pieces of the motion data for controlling moving parts of the robot, the pieces of the motion data identifying timing of movements by the moving parts, speeds of the movements by the moving parts, and at least one of a tilt angle or rotation angle associated with each of the movements by the moving parts;
generating the motion data by combining the pieces of motion data; and
transmitting the motion data to the robot such that the robot performs the motion.

15. The method of claim 14, wherein receiving the command includes:
receiving a first input to select one of the moving parts of the robot;
receiving a second input selecting an tilt angle of the moving part; and
receiving a third input selecting a rotation angle of the moving part.

16. The method of claim 14, wherein receiving command further includes setting motion times associated with the pieces of the motion data.

17. The method of claim 14, further comprising:
detecting movement of an object included a video; and
extracting the motion data based on the detected movement of the object included the video.

18. The method of claim 14, further comprising:
displaying a list identifying distinguishing user-generated motion data and user-purchased motion data; and
displaying an icon that, when selected, causes the terminal to forward at least a portion of the user-generated motion data to another device.

19. The method of claim 14, further comprising:
displaying an icon that, when selected, causes the motion data to be set according to a playback of multimedia content.

20. The method of claim 14, wherein receiving the command includes:
inverting, based on a first command, a movement by one of the moving parts of the robot;
modifying, based on receiving a second command, a speed of the movement by the moving part; and
modifying, based on the receiving a third command, the motion data such that the movement of the moving part is performed by another one of the moving parts.
